(19) United States
(12) Patent Application Publication
(10) Pub. No.: US 2025/0291855 A1
(43) Pub. Date: Sep. 18, 2025

(54) HIERARCHICAL CONTENT ORGANIZATION FOR IMPROVED INDEXING AND RETRIEVAL

(71) Applicant: Vonix Systems, LLC, Denver, CO (US)

(72) Inventors: Skyler Witman, Draper, UT (US); James Lang, Brighton, CO (US); Brent Richards, Littleton, CO (US); Nate Taylor, Castle Rock, CO (US)

(21) Appl. No.: 18/605,639

(22) Filed: Mar. 14, 2024

(51) Int. Cl. G06F 16/951; G06F 16/9535; G06F 16/954

(52) U.S. Cl. CPC G06F 16/951; G06F 16/9535; G06F 16/954

(57) ABSTRACT

Aspects of the present disclosure relate to hierarchical content organization techniques, which may thus enable improved content indexing and/or retrieval, among other benefits. In examples, a content platform maintains a content hierarchy, where, for example, each category within the content hierarchy has an associated set of categories/subcategories. It will be appreciated that any number of hierarchical levels may be used. Accordingly, a post or other content item may be associated with one or more categories/subcategories (e.g., one or more nodes) of the content hierarchy, thereby facilitating subsequent retrieval of the content (e.g., responsive to a user query and/or to provide to a search platform). Thus, in contrast to discussion boards and other content management systems, the disclosed aspects ensure content is organized when created, thereby improving later retrieval and/or any of a variety of subsequent processing, among other benefits.

### BACKGROUND

In examples, user-generated content (UGC) is stored by a content platform. However, it may be difficult to organize UGC in a way that it is subsequently retrievable in a variety of contexts (e.g., in response to a user search and/or for availability to a search platform). This may be especially true in instances where there is a large volume of UGC and/or where the UGC relates to a substantial number of different topics, such that traditional content organization, indexing, and/or retrieval techniques are ineffective or otherwise inefficient, thereby diminishing user experience and/or resulting in an inability by the content platform to identify relevant UGC, among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to hierarchical content organization techniques, which may thus enable improved content indexing and/or retrieval, among other benefits. In examples, a content platform maintains a content hierarchy, where, for example, each category within the content hierarchy has an associated set of subcategories. It will be appreciated that any number of hierarchical levels may be used. For instance, each subcategory may thus each have an associated set of further subcategories (e.g., thus acting as a parent category to each subcategory, or child category, thereunder) Accordingly, a post or other content item may be associated with one or more categories/subcategories (e.g., one or more nodes) of the content hierarchy, thereby facilitating subsequent retrieval of the content (e.g., responsive to a user query and/or to provide to a search platform). Thus, in contrast to discussion boards and other content management systems, the disclosed aspects ensure content is organized when created, thereby improving later retrieval and/or any of a variety of subsequent processing, among other benefits.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which hierarchical content organization may be used for processing user-generated content according to aspects described herein.

FIG. 2 illustrates a conceptual overview of an example content hierarchy according to aspects described herein.

FIG. 3A illustrates an overview of an example method for generating a new SME profile for a user profile within a hierarchical content store according to aspects described herein.

FIG. 3B illustrates an overview of an example method for transferring an SME profile between user profiles within a hierarchical content store according to aspects described herein.

FIG. 4A illustrates an overview of an example method for processing user-generated content at a user computing device to add the content to a hierarchical content store according to aspects described herein.

FIG. 4B illustrates an overview of an example method for processing user-generated content at a server computing device to add the content to a hierarchical content store according to aspects described herein.

FIG. 5A illustrates an overview of an example method for searching for user-generated content at a user computing device according to aspects described herein.

FIG. 5B illustrates an overview of an example method for processing a search request at a server computing device according to aspects described herein.

FIG. 6 illustrates an overview of an example method for generating a response to a request from a search platform based on content from a hierarchical content store according to aspects described herein.

FIG. 7 illustrates an overview of an example method for associating user-generated content with a profile based on an identifier associated with the profile according to aspects described herein.

FIG. 8A illustrates an overview of an example method for directing a user computing device to a vendor computing device according to aspects described herein.

FIG. 8B illustrates an overview of another example method for directing a user computing device to a vendor computing device according to aspects described herein.

FIGS. 9A-9F illustrate overviews of example user interfaces relating to a user profile according to aspects described herein.

FIGS. 10A-10I illustrate overviews of example user interfaces relating to a subject matter entity profile according to aspects described herein.

FIGS. 11A-11F illustrate overviews of example user interfaces relating to creating user-generated content according to aspects described herein.

FIG. 12 illustrates an example of a suitable computing environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a content platform enables interaction between a group of users. For example, a user shares user-generated content (UGC; also referred to herein as a post) using the content platform, such that one or more other users may comment on or otherwise interact with (e.g., like, upvote, downvote, etc.) the post. Example posts include, but are not limited to, a showcase post, a review post, a tutorial post. It will be appreciated that a post can include any of a variety of content, including, but not limited to, text, image, audio, and/or video content. In examples, a post includes a title, one or more tags, and/or a link to an associated product and/or service, among other examples. In some instances, content is associated with a location (e.g., as may be determined by a computing device via which the content is posted). While aspects are described with respect to a content hierarchy, a geographical hierarchy may additionally or alternatively be used to categorize content of a content platform according to aspects described herein. In examples, content can be identified from the content platform according to geographic proximity (e.g., to a user and/or to a specified location), thereby facilitating content discovery by users at a similar geographic location. While examples are discussed herein with respect to user-generated content, it will be appreciated that similar techniques may be used for any of a variety of other content types, including, for example, machine-generated content.

However, given a variety of content can be submitted to the content platform, organizing such content may be difficult, especially in instances where the content platform manages content relating to a wide array of topics and/or in instances where a large volume of content is managed by the content platform, among other examples. For instance, if the UGC is in the form of a discussion board, numerous threads may be used, where each thread has an associated set of posts. In examples, the set of posts is presented to a user chronologically and/or as a series of pages, where each page has an associated subset of posts. However, manually identifying relevant content from such a discussion board thread may be challenging for a user, as the user may need to review multiple historical pages in order to have context for a more recent post and/or to identify content for which the user is looking. Similarly, searching such content to identify content to a user that is responsive to a user's search query (also referred to herein as “relevant content”) may be challenging, as mere keyword searching may fail to meaningfully differentiate between posts within one or more such threads. For instance, a post may quote previous one or more previous posts and/or a number of posts may include similar keywords, such that they may each be provided in a result set for a given keyword search query, even though they may not actually be relevant to a given search intent.

Accordingly, aspects of the present disclosure relate to hierarchical content organization techniques, which may thus enable improved content indexing and/or retrieval, among other benefits. In examples, a content platform maintains a content hierarchy, where, for example, each category within the content hierarchy has an associated set of subcategories. It will be appreciated that any number of hierarchical levels may be used. For example, a set of categories at a first level may each have a set of associated subcategories at a second level, where a subcategory of the second level has an associated set of subcategories at a third level, and so on. Accordingly, a post or other content item may be associated with one or more categories/subcategories (e.g., one or more nodes) of the content hierarchy, thereby facilitating subsequent retrieval of the content (e.g., responsive to a user query and/or to provide to a search platform). Thus, in contrast to discussion boards and other content management systems, the disclosed aspects ensure content is organized when created, thereby improving later retrieval and/or any of a variety of subsequent processing.

In some instances, the content platform is a specialized content platform, where content managed by the content platform corresponds to one or more subject matter areas. Example specialized content platforms include, but are not limited to, a vehicle content platform, a firearms content platform, a timepiece content platform, a travel content platform, and/or a sporting content platform (e.g., golf, tennis, baseball, etc.), among other examples. Such a specialized content platform has a corresponding content hierarchy that facilitates organization of content associated with the one or more subject matter areas, thereby improving the ability of relevant content to be identified (e.g., for presentation to a user and/or for providing to a search platform).

For example, if the specialized content platform is a vehicle content platform, the first level of the content hierarchy may include the categories of performance, suspension, drive train, wheels/tires, electrical, lighting exterior, interior, and/or maintenance, among other examples. Hierarchically, the performance category may have the subcategories of engine, intake, electronic control unit (ECU) tuning, fuel system, forced induction, cooling system, exhaust, and/or braking, among other examples. The suspension category may have the subcategories of lift kit, airbags, shocks, springs, control arms, links, stabilizers, and/or leveling, among other examples. The drive train category may have the subcategories of transmission, axels, clutch, drive shafts, steering, and/or shifter, among other examples. The wheels/tires category may have the subcategories of wheels, tires, wheel paint, spaces, mounting equipment, and/or repair, among other examples. The electrical category may have the subcategories of battery, ECU control module, engine compartment, wire harness, indicator, switches, and/or controller area network (CAN) bus, among other examples. The lighting category may have the subcategories of headlights, taillights, fog lights, light bar, spotlight, under-glow, and/or light-emitting diodes (LEDs), among other examples. The exterior category may have the subcategories of paint, vinyl wrap, body, skid plates, protection, spoilers, splitters, wings, and/or custom modifications, among other examples. The interior category may have the subcategories of seats, shift knob, sound system, trim, safety, carpet, dashboard, electronics, and/or mirrors, among other examples. The maintenance category may have the subcategories of routine maintenance and/or preventative maintenance, among other examples.

Other examples of specialized content include, but are not limited to: fitness/wellness (e.g., exercise routines, healthy living, nutrition, wellness tips, holistic health approaches, alternative medicine, and mindfulness), watercraft, technology/gadgets (e.g., latest gadgets, software, and tech trends), gaming (e.g., video games, board games, and online gaming communities), cooking and culinary arts (e.g., recipes, cooking techniques, and culinary innovations), fashion and style (e.g., latest fashion trends, makeup, and style advice), photography (e.g., camera equipment, photography techniques, and sharing photos), do-it-yourself and home improvement (e.g., home decor, renovations, and do-it-yourself projects), parenting (e.g., parenting tips, child development, and family-related discussions), pets and animals (e.g., pet care, animal behavior, and cute pet photos), science and technology (e.g., breaking news in the world of science and technology), music (e.g., different genres, new releases, and concert experiences), fitness and bodybuilding (e.g., weightlifting, bodybuilding routines, and fitness challenges), finance and investment (e.g., personal finance, investing strategies, and financial advice), self-improvement (e.g., personal development, motivation, and success stories), outdoor activities (e.g., hiking, camping, and outdoor adventure discussions), anima and manga (e.g., animated series and Japanese comics), books and literature (e.g., book recommendations, literary discussions, and author fan clubs), home gardening (e.g., tips for gardening, plant care, and landscaping), and/or collectables (e.g., stamps, coins, action figures, and other collectibles), among other examples.

While example categories and subcategories are provided, it will be appreciated that such aspects are provided for illustrative purposes and, in other examples, any of a variety of additional or alternative categories and/or subcategories can be used. Further, it will be appreciated that a content hierarchy may include any number of levels, such that one or more such subcategories may itself have a corresponding set of subcategories (e.g., at a third level), and so on.

In examples, a user of the content platform has an associated user profile. The user profile stores any of a variety of information associated with the user, including, but not limited to, a username, a real name, contact information (e.g., an email address, a phone number, a mailing address), demographic information (e.g., age, location), likes and/or interests, billing information (e.g., a payment method, a payment type, an account number, a billing address), one or more user preferences, and/or a friends list that includes an association with one or more other users of the content platform. When the user posts content to the content platform, an association may be formed between the user's profile and the content item, thereby enabling the content to be retrieved from the user's profile or the user's profile to be retrieved via the content item, among other examples.

In some instances, the content platform includes one or more other types of profiles. For example, a subject matter entity (SME) profile stores information associated with the entity. As noted above, a specialized content platform manages content that corresponds to one or more subject matter areas. Accordingly, an SME profile may be used by a user of the content platform to detail an entity of the user that is associated with the subject matter covered by the content platform. As an example, if the content platform is for vehicles, an SME profile may correspond to a vehicle of the user. As another example, if the content platform is for golf, an SME profile may correspond to a golf club of the user. As a further example, if the content platform is for firearms, an SME profile may correspond to a firearm of the user.

Similar to a user profile, an SME profile stores details associated with an entity. Returning to the example of a vehicle profile, the SME profile may store specifications of the vehicle, including, but not limited to, a vehicle identification number (VIN), make, model, model year, weight, engine displacement, horsepower, drivetrain information, and/or wheel/tire specifications, among other information. In examples, the SME profile further includes one or more pictures, videos, and/or audio clips that correspond to the SME.

In some instances, the content platform includes a “builder” utility, with which a user can create or modify an SME entity associated with the user's profile. For example, the builder utility includes a set of steps through which the user provides information associated with an SME, thereby populating various specifications and/or other information about the SME. In some examples, the builder utility validates, sanitizes, and/or otherwise processes data that is obtained from the user and/or any of a variety of other data sources prior to storing it as part of the SME profile.

Returning to the vehicle profile example, a user may provide a VIN (e.g., as text input and/or as a result of scanning a barcode) that is processed by the content platform to automatically populate various information associated with the SME. In examples, the content platform communicates with a third-party data source (e.g., via an application programming interface or “API”) to obtain information associated with VIN. In some instances, information obtained in association with the VIN is processed to validate other information of the SME profile (e.g., as may have been obtained from the user), such that discrepancies may be noted. Accordingly, the user corrects such discrepancies and/or indicates such differences are due to aftermarket modifications to the vehicle, among other examples. Such processing may also serve to validate the existence of the vehicle (e.g., as compared to a vehicle profile having no associated VIN).

In examples, a user profile has one or more associated SME profiles, such that the SMEs are displayed and are accessible (e.g., by another user of the content platform) via the user's profile. For instance, in the context of the vehicle example, associated vehicle profiles are displayed in a “garage” portion of the user's profile. In some instances, SME profiles are transferrable between users, for example as may be the case if a first user transfers ownership of an SME to a second user. In such an instance, a snapshot of the SME profile may remain associated with the first user profile, while a current/editable version of the SME profile is associated with the second user profile. Thus, it may be possible to view a transaction history for a given SME via the SME profile. As another example, the content platform may prompt a new owner (e.g., the second user in the above example) to import a pre-existing SME profile, at which point the SME profile may be snapshotted and associated with the new owner's user profile accordingly.

As another example profile type, a vendor profile may be associated with a vendor (e.g., for a business or a service provider). Aspects of a vendor profile may be similar to a user profile, for example including a name and contact information corresponding to the vendor. In examples, a user associated with a vendor profile is able to create groups and/or events. In examples, the content platform facilitates or otherwise enables transaction processing in association with the vendor profile, for example to enable one or more other users of the platform to obtain tickets to an event and/or to obtain a good and/or service, among other examples. Additionally, or alternatively, the content platform provides a set of analytics via the vendor platform, for example relating to user engagement, referral statistics, and/or lead generation to enable a user associated with the vendor profile to discover one or more other profiles of the content platform. Additionally, or alternatively, such analytics include review information (e.g., an average star rating and/or customer sentiment), as may be generated based on review posts associated with a product/service of the vendor.

In examples, the content platform generates a quick response (QR) code, a barcode, or other graphical representation associated with a vendor profile, which is usable to associate content with the vendor profile accordingly. For instance, the graphical representation encodes a unique identifier associated with the vendor profile. Accordingly, if a user creates a post, the user may scan the graphical representation (e.g., before or after post creation), such that the content platform associates the post with the vendor profile accordingly. Thus, the computing device of the user processes the graphical representation to generate an identifier having an associated vendor profile, which may be provided to the content platform in association with content of the post, which is thus used by the content platform to generate the association between the content and the vendor profile according to aspects described herein. This may further facilitate content organization and metadata generation for content managed by the content platform.

It will be appreciated that a QR code may be associated with any of a variety of other content of a content platform according to aspects described herein. For example, a QR code may correspond with a user profile, a subject matter entity profile, a post, a category, and/or a subcategory, among other examples. Thus, a user may display their QR code for another user to scan, thereby facilitating easy access to that user's content by other users (e.g., at an in-person meetup).

As noted above, a post or other content item may be associated with one or more nodes of a content hierarchy of the content platform. In examples, the post is further associated with one or more profiles, such as a user profile, an SME profile, and/or a vendor profile, among other examples. For instances, as a result of further associating a post with an SME profile, the content item may be identifiable (e.g., when browsing or as a result of a search query) via the SME profile, thereby enabling a user to find the content item as a result of searching, at least in part, for an SME corresponding to the SME profile.

Returning to the vehicle example, a user may search for a make/model of vehicle, such that an association between a content item and a responsive vehicle profile is used to identify and/or increasing the ranking of the content item. Similarly, multiple such vehicle profiles may be identified (e.g., as may each be associated with a user profile), such that a set of identified content items includes content items that each have an associated vehicle profile that relates to the vehicle make/model specified by the user's search query. Additionally, or alternatively, the set of content items is identified and/or further filtered by a user's selection of one or more nodes within a content hierarchy, thereby further limiting the content items that are provided to the user in response to the search query. Additionally, or alternatively, the content items are filtered according to an associated review score (e.g., out of five stars, on a scale from one to ten, etc.), thereby enabling a user to identify review posts above such a review score threshold.

Given content of the content platform is organized as a result of the disclosed aspects, the identification of relevant content for indexing by a search platform is also improved. For instance, search engine optimization (SEO) may be improved as a result of the ability to identify relevant content and to further populate a response that includes at least a part of the identified content with metadata based on an association with one or more nodes of the content hierarchy and/or one or more associated profiles (e.g., a user profile, a vendor profile, and/or an SME profile). In an example, the metadata is generated based on any of a variety of fields that would otherwise be populated for display to a user, including, but not limited to, a post title and/or information from an SME profile (e.g., returning to the vehicle example, a make/model/year, etc.).

In examples, the content platform further provides discussion functionality, such that users can comment on posts and/or crosslink posts (e.g., from a user profile and/or from another post), among other examples. Similar to the above-described aspects, a comment or response to a post (which may itself be a post, also referred to herein as a subsequent post) may be categorized according to one or more nodes of the content hierarchy. In examples, the subsequent post is associated with the same and/or a different node of the content hierarchy accordingly. For instance, a user may identify a different node of the content hierarchy when drafting the post, such that the post is associated with the different node accordingly. Similarly, a subsequent post is associated with the same and/or a different SME profile (e.g., as may be the case if a first user references their own SME in response to a post associated with an SME profile of a second user). Thus, the content hierarchy further enables an organizational structure that is additional to and separate from a structure associated with the discussion functionality (e.g., as a set of posts or as a hierarchical conversation flow in which replies are added as nodes beneath a post to which they are responding).

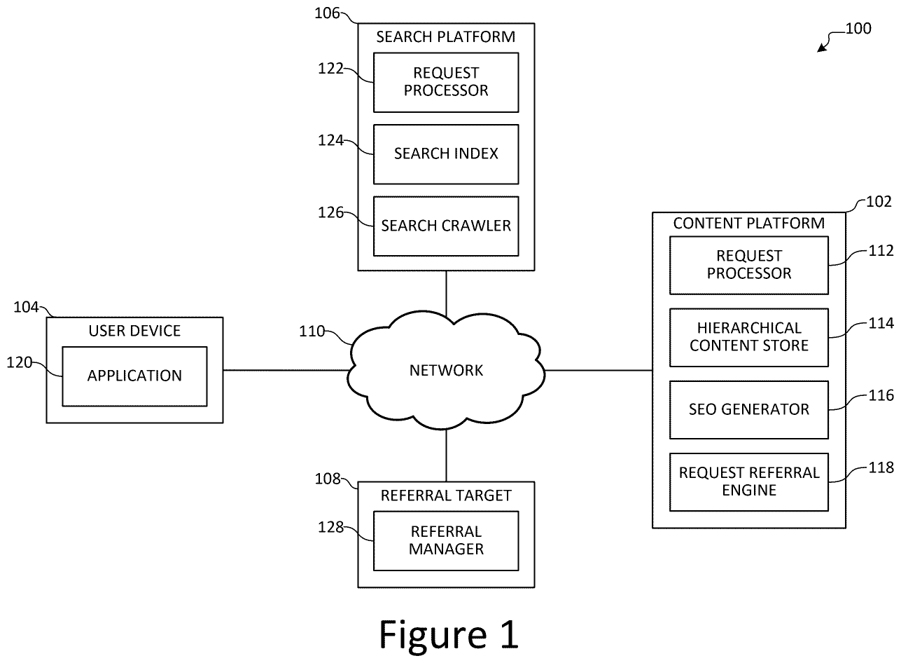

FIG. 1 illustrates an overview of an example system 100 in which hierarchical content organization may be used for processing user-generated content according to aspects described herein. As illustrated, system 100 includes content platform 102, user device 104, search platform 106, referral target 108, and network 110. In examples, content platform 102, user device 104, search platform 106, and/or referral target 108 may communicate via network 110, which may comprise a local area network, a wireless network, or the Internet, or any combination thereof, among other examples.

In examples, a user operates application 120 of user device 104 to post content on content platform 102 and/or to access content of content platform 102 (e.g., which may be user-generated content from one or more other users of content platform 102 and/or as may be machine-generated content), among other examples. As another example, application 120 is usable to capture and/or provide information for an SME profile. For example, the user operates application 120 to scan a barcode, QR code, or to perform object recognition, and/or to enter information associated with an SME in order to create the SME profile that is thus associated with the user's profile according to aspects described herein. It will be appreciated that application 120 may implement any of a variety of alternative and/or additional functionality, including, but not limited to, search functionality (e.g., to identify a set of content items based on a user query and/or filters applied based on a content hierarchy of content platform 102), discussion functionality, and/or event functionality (e.g., to register for events and/or to obtain event tickets), among other examples.

System 100 further includes content platform 102, which is illustrated as comprising request processor 112, hierarchical content store 114, SEO generator 116, and request referral engine 118. In examples, request processor 112 processes requests from user device 104 and/or search platform 106, among other examples. For instance, request processor 112 receives a request for content from user device 104 (e.g., as a result of a user browsing a content hierarchy and/or as a query for content), such that relevant content is identified (e.g., from hierarchical content store 114) and provided in response. As another example, request processor 112 receives a request to generate a profile (e.g., a user profile, an SME profile, and/or a vendor profile), such that a profile is generated within hierarchical content store 114 accordingly. As another example, request processor 112 processes a request from search platform 106, where, for example, SEO generator 116 generates a response that includes metadata for SEO based on data from hierarchical content store 114 according to aspects described herein.

Hierarchical content store 114 stores any of a variety of content for content platform 102. For example, hierarchical content store 114 stores a content hierarchy and a set of posts and/or other content items in association with various nodes therein. Hierarchical content store 114 may store any of a variety of profiles for content platform 102, including, but not limited to, a user profile, an SME profile, and/or a vendor profile. In examples, one or more content items of content platform 102 are further associated with one or more such profiles. Thus, as a result of such associations between a content item, a node of the content hierarchy, and/or a profile of hierarchical content store 114, content of content platform 102 may be more easily retrievable and may further be enriched accordingly (e.g., by SEO generator 116, so as to provide metadata with which search platform 106 may rank content of content platform 102 accordingly). For instance, SEO generator 116 identifies a content item, an associated node of a content hierarchy, and/or one or more associated profiles, such that an indication of the associated node and/or one or more associated profiles is provided in conjunction with at least a part of the content item (e.g., in response to a request from search platform 106).

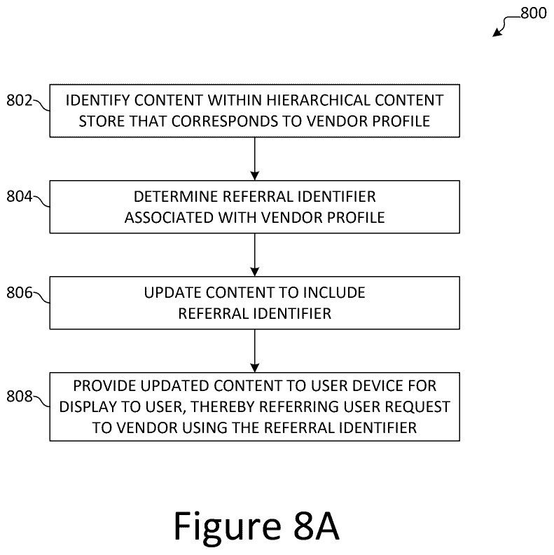

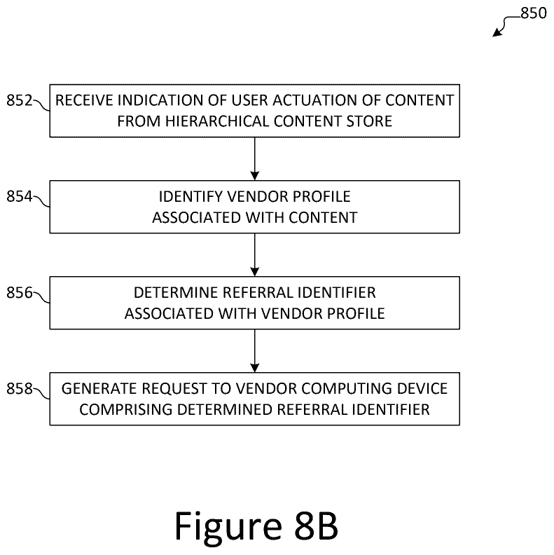

Request referral engine 118 processes a content item to generate a referral indication that is included therein (e.g., to referral target 108). For example, a content item may include an indication of a vendor from which a good was obtained or by which a service was performed (e.g., as may be provided by a user and/or as may result from an association with a vendor profile). Accordingly, the referral indication comprises a reference to the vendor (e.g., as an email address, a phone number, an instant messaging username, and/or as a uniform resource locator, or URL), thereby enabling a user of content platform 102 to use a computing device to interact with the vendor (e.g., via an electronic messaging application and/or a website of the vendor) accordingly. In examples, the referral indication includes an identifier associated with content platform 102. For instance, request referral engine 118 communicates with referral manager 128 of referral target 108 (which may be a vendor, having an associated vendor profile) to obtain such a referral identifier. It will be appreciated that any of a variety of other techniques may be used to obtain a referral identifier and/or integrate the referral identifier into a content item according to aspects described herein. For instance, referral manager 128 provides a token that is included by request referral engine 118 accordingly. In examples, such an indication is included if a referral identifier is available for the vendor. Accordingly, the indication may be omitted in instances where the vendor does not have an associated referral identifier. Additional examples of such aspects are discussed below with respect to FIGS. 8A and 8B.

System 100 is further illustrated as including search platform 106. As illustrated, search platform 106 includes request processor 122, search index 124, and search crawler 126. In examples, search crawler 126 indexes content (e.g., of content platform 102 and/or from any of a variety of other data sources) for retrieval (e.g., by a user of user device 104), which may be stored in search index 124. Accordingly, when request processor 122 processes a request for content, which may include a search query, request processor 122 identifies content that is responsive to the search query from search index 124. In examples, when search crawler 126 accesses content of content platform 102, search crawler 126 provides an indication that it is a crawler (e.g., as compared to a web browser or other application that is operated by a user of content platform 102), such that request processor 112 uses SEO generator 116 to generate metadata with which to enrich content of content platform 102 according to aspects described herein. Such aspects may improve the indexability of the content, thereby making the content more easily retrievable and/or increasing the search ranking thereof, among other examples.

Finally, system 100 is illustrated as including user device 104. In examples, user device 104 is a mobile computing device, a tablet computing device, a laptop computing device, and/or a desktop computing device, among other examples. As noted above, a user may operate user device 104 to access content platform 102 and/or to search via search platform 106, among other examples. User device 104 is illustrated as including application 120, which may be a web browser or may access content platform 102 via an API, among other examples. While various functionality is described with respect to content platform 102, user device 104, search platform 104, and referral target 108, it will be appreciated that such functionality may be distributed according to any of a variety of other paradigms in other examples. For instance, application 120 may filter content items (e.g., of hierarchical content store 114, as may be provided by request processor 112) according to a content hierarchy in response to a user selection of one or more nodes therein. As another example, application 120 may implement aspects of request referral engine 118, such that a content item is processed local to user device 104 rather than being processed at content platform 102 prior to providing the content item to user device 104.

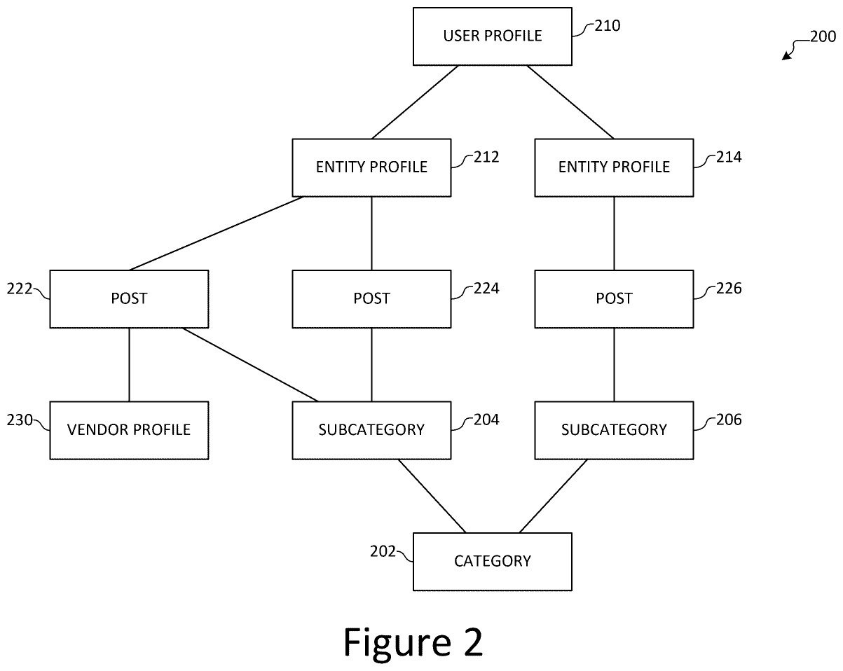

FIG. 2 illustrates a conceptual overview of an example content hierarchy 200 according to aspects described herein. Aspects of content hierarchy 200 may be similar to those of hierarchical content store 114 discussed above with respect to FIG. 1 and are therefore not necessarily redescribed below in detail. It will be appreciated that content hierarchy 200 is simplified for illustrative purposes and, in other examples, any number of posts, profiles, and/or hierarchical levels may be used.

As illustrated, content hierarchy 200 includes posts 222, 224, and 226, each of which may include any of a variety of content according to aspects described herein. For example, post 224 may have been authored by a user operating user device 104 via application 120 discussed above with respect to FIG. 1. In examples, the user is associated with user profile 210. As illustrated, post 224 is associated with SME profile 212 (which itself is associated with user profile 210) and subcategory 204, thereby indicating post 224 includes content associated with an SME to which SME profile 212 corresponds and is also associated with subcategory 204 (and, more generally, category 202). Accordingly, post 224 may be identifiable via content therein (e.g., as a result of a keyword search, pattern matching, or semantic similarity), via the association with entity profile 212 (e.g., as a result of specifications and/or other information contained therein), based on an indirect association with user profile 210, and/or as a result of the association with subcategory 204 and/or category 202 (e.g., as a result of a user filtering based on subcategory 204 and/or category 202).

Content hierarchy 200 further includes post 226, which is associated with SME profile 214 and subcategory 206. Similar to post 224, post 226 may thus be identifiable via content of post 226, as a result of the association with SME profile 214, as a result of the association with subcategory 206, and/or as a result of the (indirect) association with category 202, among other examples. As compared to post 224, post 226 is associated with a different SME profile (e.g., SME profile 214 rather than SME profile 212) and a different subcategory (e.g., subcategory 206 instead of subcategory 204). However, post 226 is associated with the same user profile (e.g., user profile 210) and category (e.g., category 202), such that post 226 may be displayed alongside post 224 in some examples.

Content hierarchy 200 is further illustrated as including post 222, which is associated with SME profile 212, subcategory 204, and vendor profile 230. Thus, similar to post 224, post 222 may be identified as a result of the association with SME profile 212 and/or subcategory 204, as well as the indirect association with user profile 210 and/or category 202. However, in contrast to posts 224 and 226, post 222 is further association with vendor profile 230, thereby enabling identification of post 222 via vendor profile 230 and/or of vendor profile 230 via post 222, among other examples.

Thus, as noted above, content within content hierarchy 200 may be accessible by virtue of any number of associations, including, but not limited to, an association with a category/subcategory, an association with an SME profile, and/or an association with a user/vendor profile, among other examples. Additionally, or alternatively, an SME profile, a category/subcategory, and/or a user/vendor profile may be accessible via a post as a result of such an association. It will therefore be appreciated that the associations enabled by a content hierarchy according to aspects described herein may thus facilitate content/profile discovery, content organization, and improve the browsability of data or otherwise managed by a content platform, among other examples. Further, it will be appreciated that any number of levels (e.g., of subcategories) may be used in a content hierarchy and/or that any of a variety of additional or alternative profile types may be used in other examples.

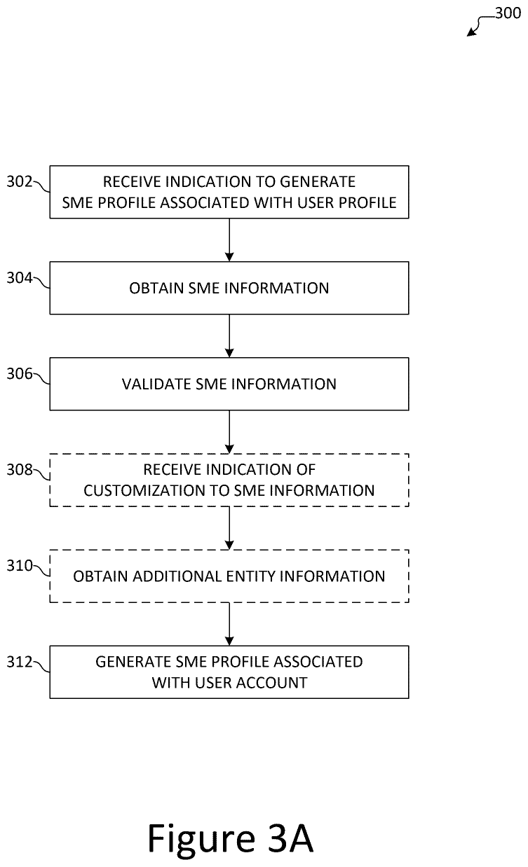

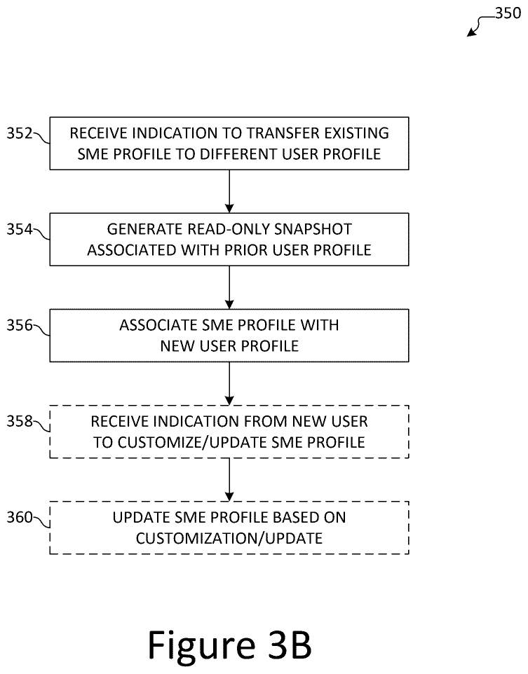

FIG. 3A illustrates an overview of an example method 300 for generating a new SME profile for a user profile within a hierarchical content store according to aspects described herein. In examples, aspects of method 300 may be performed by a content platform, such as content platform 102 discussed above with respect to FIG. 1. For instance aspects of method 300 may be performed by a request processor, such as request processor 112.

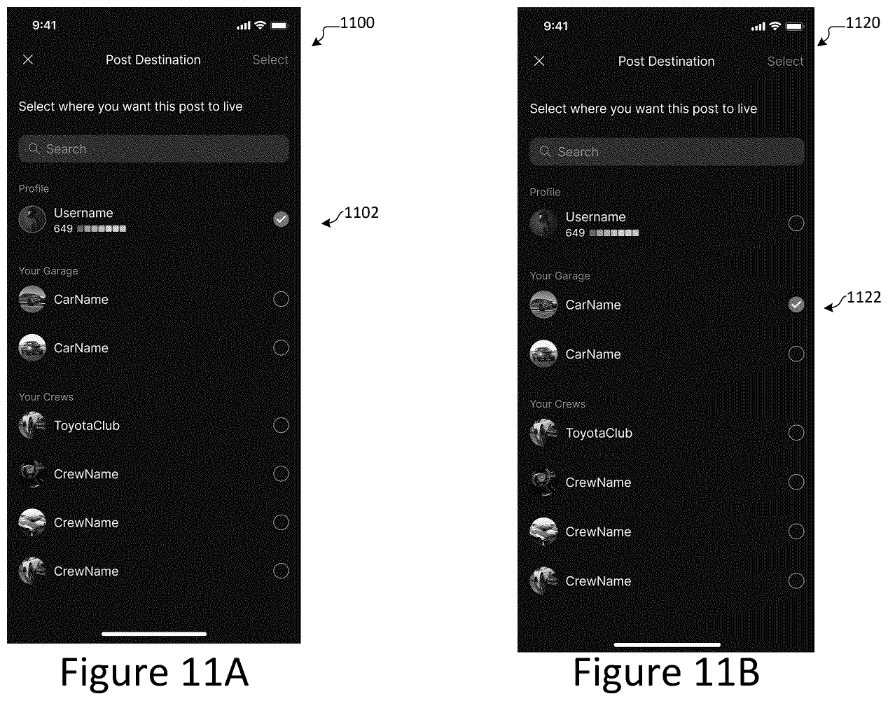

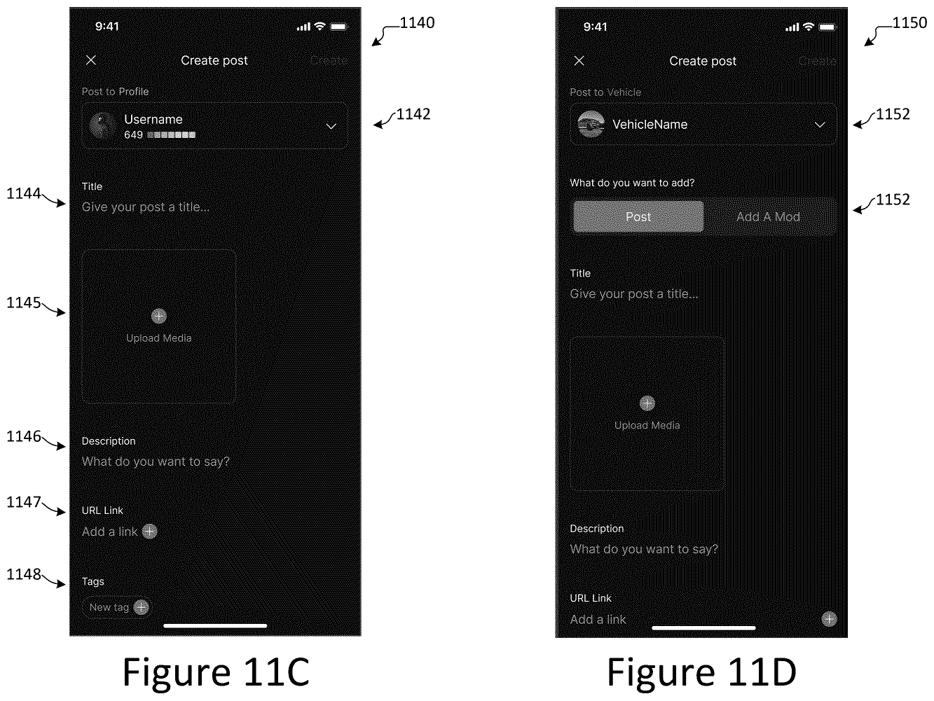

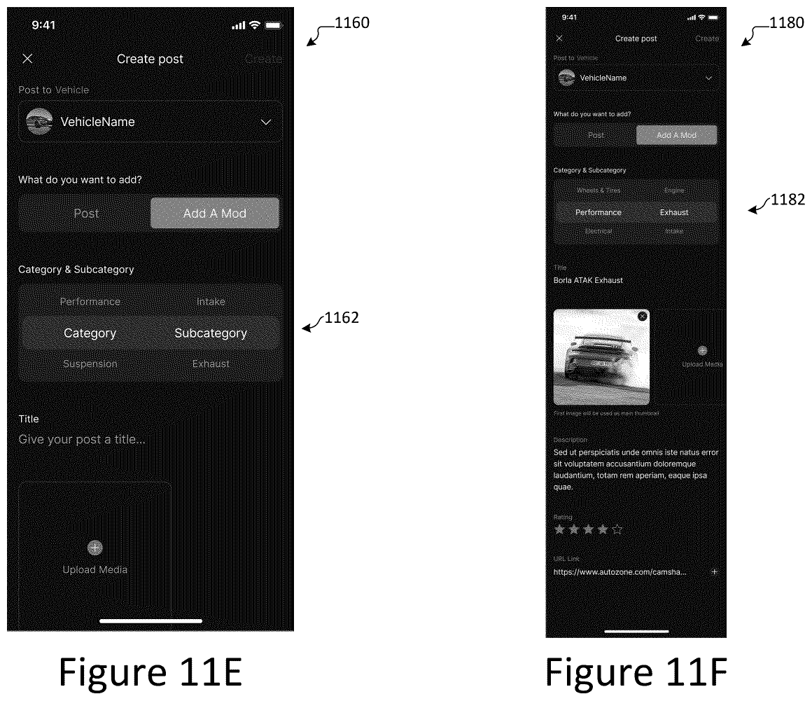

As illustrated, method 300 begins at operation 302, where an indication is received to generate an SME profile associated with a user profile. In examples, the indication is received as a result of a user operating an application of a user device (e.g., application 120 of user device 104 in FIG. 1) to enter information associated with the SME according to aspects described herein. Additional examples of such aspects are discussed below with respect to FIGS. 11A-11C. For instance, the indication includes a VIN, a serial number, or other identifier associated with the SME. Additionally, or alternatively, the indication comprises an indication as to an SME type. It will therefore be appreciated that the indication may include any of a variety of information or, as another example, need not include information associated with the SME (as such information may additionally or alternatively be obtained at operation 304 discussed below).

Flow progresses to operation 304, where SME information is obtained. In examples, the information is obtained from the user device from which the indication was received at operation 302. For instance, the user enters information at the user device, which is transmitted to the content platform at which method 300 is being performed. In examples, operation 304 comprises multiple transactions with the user device, for example where a user provides a first set of SME information via the user device, after which the first set of SME information is processed to determine a second set of SME information to request from the user, such that multiple, successive sets of SME information may be obtained from the user device (e.g., where a successive set of SME information that is requested from the user device is dependent on one or more previously provided sets of SME information).

Additionally, or alternatively, operation 304 comprises obtaining SME information from any of a variety of other data sources. For instance, a third-party data source may maintain a database or catalog of SME information that is usable by the content platform to prepopulate or otherwise enrich SME information (e.g., as may have been received from the user device). In examples, the indication received at operation 302 comprises an identifier or other information that is usable to obtain the SME information from such a third-party data source accordingly.

Moving to operation 306, the SME information is validated. In examples, operation 306 comprises processing the SME information that was obtained at operation 304 according to a set of rules, using pattern matching (e.g., to confirm that the obtained SME information conforms to a pre-defined pattern), and/or using a third-party service, among other examples.

In examples, it may be determined that at least a part of the SME information that was obtained for the SME differs from expected SME information for the SME. In such an instance, aspects of the SME information that differ from the expected SME information may be noted or otherwise tagged, thereby enabling later identification and/or additional processing of such aspects. For example, in an instance where the SME is a vehicle, an indication may be provided that the vehicle has been modified from its stock/factory configuration, such that one or more differing aspects may be highlighted or otherwise emphasized to a user that is viewing an SME profile associated with the vehicle.

Moving to operation 308, an indication is received to customize the SME information. For example, the indication may be received as a result of a user deciding to further customize SME information that was obtained from a third-party at operation 304. Similar to the above-noted aspects, such a customization may result from a user identifying an aspect of the SME that differs from SME information that was obtained from a third-party data source, such that, at operation 310, the user may provide information that replaces and/or elaborates on SME information that was obtained from the third-party.

Operations 308 and 310 are illustrated using dashed boxes to indicate that, in other examples, operations 308 and 310 may be omitted, such that flow progresses directly from operation 306 to operation 312. While example aspects are described with respect to obtaining and/or validating SME information, it will be appreciated that any of a variety of additional or alternative techniques may be used. For example, rather than obtaining SME information from a third-party data source, a content platform may maintain a database of SME information from which such information may be obtained, thereby augmenting or otherwise pre-populating SME information accordingly.

At operation 312, an SME profile is generated in association with a user profile. In examples, the SME profile includes one or more properties and associated values that are populated based on the SME information that was obtained (e.g., as a result of performing aspects of operations 304, 306, 308, and/or 310 discussed above). It will be appreciated that the SME profile may store any of a variety of content in such properties, including, but not limited to, textual data, image data, video data, and/or image data, among other examples. For instance, an SME profile for a vehicle may store one or more images/videos of the vehicle, in addition to textual data corresponding to specifications for the vehicle and/or a user description of the vehicle, among other examples. Similar to SME profile 212/214 of content hierarchy 200 in FIG. 2, the resulting SME profile may thus be stored with an association to a profile for the user (e.g., user profile 210). As illustrated, method 300 terminates at operation 312.

FIG. 3B illustrates an overview of an example method 350 for transferring an SME profile between user profiles within a hierarchical content store according to aspects described herein. In examples, aspects of method 350 are performed by a content platform, such as content platform 102 in FIG. 1. For instance aspects of method 350 may be performed by a request processor, such as request processor 112.

As illustrated, method 350 begins at operation 352, where an indication is received to transfer an existing SME profile to a different user profile. In examples, the indication is received as a result of a user operating an application of a user device (e.g., application 120 of user device 104 in FIG. 1) to transfer the SME profile to another user, thereby updating an association of the SME profile to instead be associated with a user profile of the other user. In some instances, operation 352 comprises first receiving an indication from a user device of a first user, after which a confirmation indication is received from a user device of a second user. For instance, the recipient user may first request a transfer, after which the sending user may confirm the transfer accordingly. As another example, the sending user may initiate the transfer, after which the recipient user confirms the transfer. It will therefore be appreciated that any of a variety of techniques may result in the received indication to transfer the SME profile to a different user profile.

Method 350 progresses to operation 354, where a read-only snapshot of the SME profile is generated for association with the user profile of the prior (e.g., sending) user profile. Thus, the content platform stores an SME profile for the SME that indicates a state of the SME at the time the transfer occurred. This may facilitate review of the SME over time, for instance to view a set of modifications and/or a state of the SME at the time the SME was transferred between any number of users.

As an example, a first user may have transferred the SME to a second user at a time the SME was in a stock configuration, while the second user may have performed a series of modifications to the SME such that the SME profile at the time the second user transfers the SME profile to a third user reflects that series of modifications. Thus, a user viewing a history for the SME may view a first snapshot at the time the SME profile was transferred to the second user (e.g., thus reflecting the stock configuration) and a second snapshot at the time the SME profile was transferred to the third user (thus reflecting the configuration having the series of modifications). It will be appreciated that such a snapshot may reflect any of a variety of additional or alternative information, such as a change in state of the SME (e.g., a vehicle mileage at the time of transfer).

Moving to operation 356, the SME profile is associated with the new user profile. In examples, operation 356 comprises updating an SME profile (e.g., in a content hierarchy) to reflect an association with the new user profile instead of having an association with the previous user profile. In examples, the SME profile retains an indirect association with the previous user profile via the SME profile snapshot. For instance, the previous user profile is associated with the SME profile snapshot, the SME profile snapshot is associated with the current SME profile (and/or one or more other SME profile snapshots, each of which may be associated with a user profile), and the current SME profile is thus associated the current user profile to which the SME belongs.

In examples, flow progresses to operations 358 and 360, where an indication is received from the new user to customize/update the SME profile. For instance, the user may make a modification to the SME such that the SME profile is updated accordingly, among other examples. As a result, the SME profile is updated to reflect the modification or other change to the SME information at operation 360. Operations 358 and 360 are illustrated using dashed boxes to indicate that, in other examples, they may be omitted. As illustrated, method 350 terminates at operation 360 (or, in other examples, at operation 356).

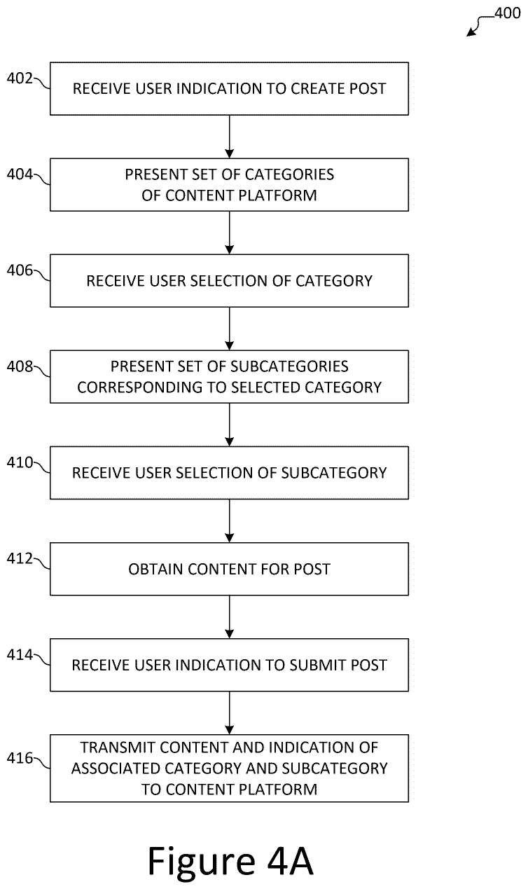

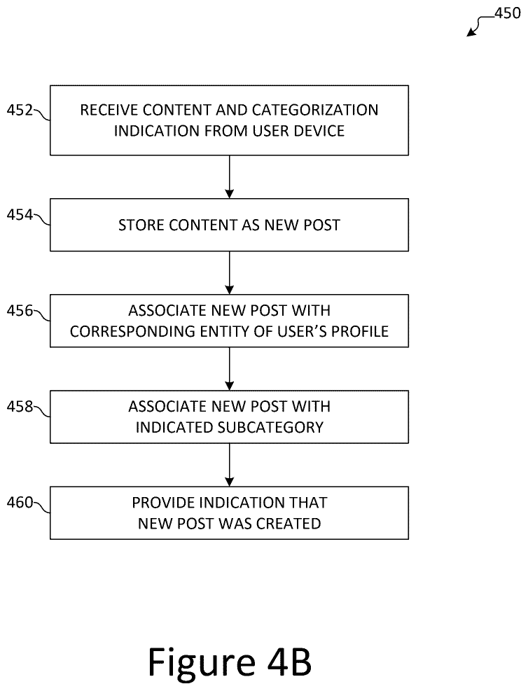

FIG. 4A illustrates an overview of an example method 400 for processing user-generated content at a user computing device to add the content to a hierarchical content store according to aspects described herein. In examples, aspects of method 400 are performed by a user device, such as user device 104 discussed above with respect to FIG. 1.

As illustrated, method 400 begins at operation 402, where a user indication is received to create a post. For example, the user indication may be received as a result of a user actuating a user interface element presented by an application (e.g., application 120 in FIG. 1). It will be appreciated that any of a variety of alternative or additional indications may be received indicating the user wishes to create a new post (e.g., as a result of pressing a hardware button or providing natural language input indicating that a new post is to be created). In examples, the indication to create a post comprises an indication of an SME for which the new post is to be created.

At operation 404, a set of categories is presented. In examples, the set of categories comprise categories via which content of the content platform is organized. Examples of such aspects were discussed above with respect to FIG. 2 and are therefore not necessarily redescribed in detail. In examples, the set of categories presented at operation 404 is narrowed or otherwise filtered based on a given SME (e.g., as may be the case when an indication as to an SME for which the new post is to be created was received at operation 402). For instance, if a content platform manages content relating to multiple types of SMEs, the set of categories may be filtered accordingly. As another example, only a subset of categories may be relevant. For instance, a first set of categories may be presented in an instance where the SME is a motorcycle, while a second set of categories may be presented in an instance where the SME is a car, even though both are more generally vehicles.

Flow progresses to operation 406, where a user selection of a category is received. In examples, the user may filter the set of presented categories to better identify which category to select. The user may tap, click, or otherwise actuate a presented category, thereby selecting it accordingly.

At operation 408, a set of subcategories that relate to the selected category are presented. Aspects of operation 408 may be similar to those discussed above with respect to operation 404 and are therefore not necessarily redescribed in detail. For instance, in addition to or as an alternative to filtering the subcategories based on a given SME, the subcategories are filtered according to the category that was selected at operation 406, thereby enabling a user to select a subcategory at operation 410 accordingly (aspects of which may be similar to those discussed above with respect to operation 406). As described above, the categories/subcategories may be selected from a content hierarchy, such that the subcategories presented at operation 408 are hierarchically associated with the category that was selected at operation 406.

While method 400 is illustrated as comprising operations 404 and 406 relating to a category and operations 408 and 410 relating to a subcategory thereof, it will be appreciated that, in other examples, additional or fewer iterations of such aspects may be performed, as may be the case when the content hierarchy includes a greater or fewer number of levels. For instance, a user may select only a category (e.g., with no subcategory) or may select a category, followed by a first subcategory and a second subcategory related thereto, among other examples.

Eventually, flow progresses to operation 412, where content is obtained for the post that is to be created. For example, content may be obtained as user input (e.g., textual content), as a result of a user selecting and/or capturing one or more photos, videos, and/or audio recordings, and/or from another data source (e.g., a third-party data source or from another post of the content platform), among other examples. It will therefore be appreciated that any of a variety of content types may be obtained at operation 412.

At operation 414, a user indication is received to submit the post. For example, the user may actuate a user interface element corresponding to post submission. As another example, the user may actuate a hardware button or provide natural language input, among other examples.

Moving to operation 416, the content and an categorization indication is transmitted to the content platform, thereby causing the content platform to store the post in a content hierarchy accordingly. In the illustrated example, the categorization indication comprises an indication as to a category (e.g., as was selected at operation 406) and an indication as to a subcategory (e.g., as was selected at operation 410), though it will be appreciated that any number of categories/subcategories may comprise a categorization indication. Additionally, or alternatively, the categorization indication includes an indication as to an SME profile, user profile, and/or vendor profile with which the post should be associated. As illustrated, method 400 terminates at operation 416.

FIG. 4B illustrates an overview of an example method 450 for processing user-generated content at a server computing device to add the content to a hierarchical content store according to aspects described herein. For example, aspects of method 450 may be performed by a content platform, such as content platform 102 in FIG. 1 so as to manage a hierarchical content store (e.g., hierarchical content store 114 and/or content hierarchy 200 in FIG. 2). For instance aspects of method 450 may be performed by a request processor, such as request processor 112.

As illustrated, method 450 begins at operation 452, where content and an associated categorization indication are received from a user device. In examples, the content and associated categorization indication are received as a result of the user device performing aspects of method 400 discussed above with respect to FIG. 4A. As noted above, the content may be any of a variety of content types and the categorization indication may indicate one or more categories, subcategories, and/or profiles with which the content is to be associated.

At operation 454, the received content is stored as a new post. For example, the post may be stored within a hierarchical content store. As another example, the post is stored in a separate store, where the content hierarchy of the content data store is then used to reference the post (and/or vice versa). In examples, the post is stored in a graph database or a relational database. It will therefore be appreciated that any of a variety of techniques may be used to store the post.

Flow progresses to operation 456, where the new post is associated with a corresponding SME profile of the user's profile. In examples, the association is indicated by the categorization indication that was received at operation 452. In other examples, operation 456 comprises automatically determining an SME profile from a set of SME profiles associated with a user's account, for example based on which SME profile has been recently edited, whether an SME profile has been favorited or otherwise indicated as a default, and/or based on whether a category/subcategory is relevant for a given SME profile, among other examples. While method 450 is illustrated as an example in which the post is associated with an SME profile, it will be appreciated that similar techniques may be used to associate a new post with a vendor profile and/or any of a variety of other profiles.

Moving to operation 458, the new post is associated with an indicated subcategory. Thus, at operation 458, the categorization indication is processed to associate the new post with one or more subcategories/categories accordingly. In some examples, operation 458 comprises automatically determining one or more additional or alternative categories and/or subcategories.

Thus, the new post that was stored at operation 454 is associated with one or more categories, subcategories, and/or profiles (e.g., via operations 456 and 458), thereby facilitating subsequent retrieval of the post (e.g., when a user is browsing or to provide to a search platform). Examples of such aspects were discussed above with respect to content hierarchy 200 in FIG. 2, where posts 222, 224, and 226 each have various associations therein.

Finally, at operation 460, an indication is provided that the new post was created. For example, the indication may be a response to the request that was received at operation 452, thereby causing the user device to provide a success indication to a user accordingly. As illustrated, method 450 terminates at operation 460.

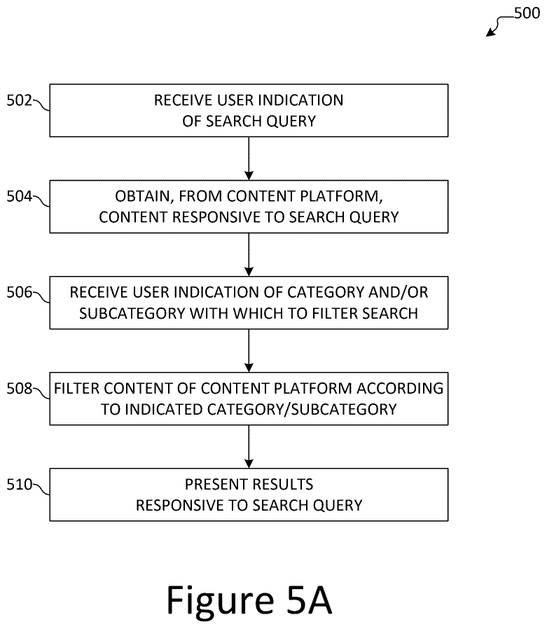

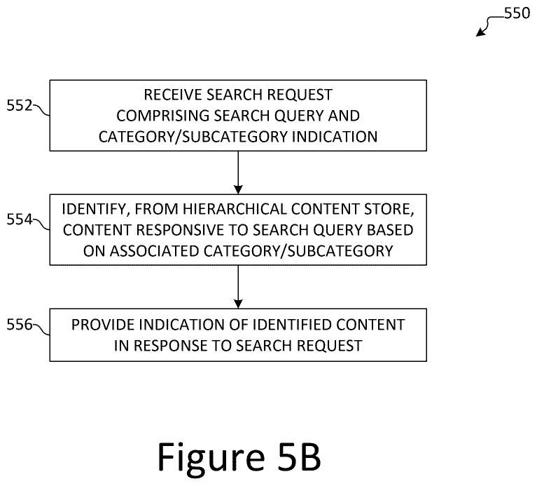

FIG. 5A illustrates an overview of an example method 500 for searching for user-generated content at a user computing device according to aspects described herein. In examples, aspects of method 500 are performed by a user device, such as user device 104 in FIG. 1.

As illustrated, method 500 begins at operation 502, where a user indication of a search query is received. In examples, the search query comprises text, as may be received via a keyboard of the user device. As another example, the search query is received as natural language input, which may be spoken by the user. Thus, it will be appreciated that the search query may be received via any of a variety of modalities.

Flow progresses to operation 504, where content that is responsive to the search query is obtained from the content platform. For example, operation 504 comprises providing a request to the content platform that comprises the search query, thereby obtaining responsive content from the content platform accordingly. It will be appreciated that any of a variety of techniques may be used to obtain the content from the content platform, for example, where responsive content is provided as one or more pages, such that responsive content is successively obtained from the content platform as a series of pages.

At operation 506, a user indication of a category and/or subcategory is received. For example, the user indication is received as a result of the user browsing a content hierarchy of the content platform, such that the user may select one or more categories and/or subcategories with which to search. It will be appreciated that, while method 500 is illustrated as an example in which an initial search query is used to obtain responsive content, similar techniques may be used to first receive a user selection as to one or more categories and/or subcategories with which to search, such that operation 504 occurs as part of operation 508 accordingly.

Moving to operation 508, the selected categories and/or subcategories are used to filter the responsive content accordingly. In examples, the responsive content is filtered by the user device or, as another example, an indication of the search filter is provided to the content platform such that the content platform provides a set of filtered content that is responsive to the search query accordingly.

Flow progresses to operation 510, where the responsive content is presented as result for the search query that was received at operation 502. Thus, as a result of organizing content according to the content hierarchy described herein, user retrieval of relevant content is improved as the user need not provide a carefully crafted search query and may alternatively or additionally restrict content identification to one or more subcategories and/or categories. Method 500 is provided as a simplified example. In other, similar examples, a user may refine a search query and/or change a selected set of categories/subcategories, such that a subsequent set of responsive content is identified and provided accordingly. Ultimately, a user may actuate or otherwise select a responsive content item, such that a corresponding post is retrieved and displayed accordingly. As illustrated, method 500 terminates at operation 510.

FIG. 5B illustrates an overview of an example method 550 for processing a search request at a server computing device according to aspects described herein. In examples, aspects of method 500 are performed by a content platform, such as content platform 102 in FIG. 1. For instance aspects of method 550 may be performed by a request processor, such as request processor 112.

As illustrated, method 500 begins at operation 502, where a search request is received. For example, the search request is received from a user device performing aspects of method 500 discussed above with respect to FIG. 5A. In examples, the search request comprises a search query and/or an indication of a category and/or subcategory with which to filter identified content.

While methods 500 and 550 are described in an example in which content is filtered according to a category/subcategory, it will be appreciated that content may be filtered according to any of a variety of additional or alternative criteria, including, but not limited to, a rating (e.g., on a scale from a high rating to a low rating), an associated profile (e.g., of an SME, a user, and/or a vendor), a time period (e.g., the last day, last week, last month, or last year), SME type (e.g., whether content relating to a vehicle is a car and/or a motorcycle, whether content relating to a firearm is a handgun or a rifle), and/or geographic location (e.g., of a post, of a user profile, and/or of a vendor profile), among other examples.

Flow progresses to operation 554, where responsive content for the given search query and/or category/subcategory is identified from a hierarchical content store. In examples, the hierarchical content store is filtered according to one or more indicated categories and/or subcategories, after which keyword searching or fuzzy matching is used to identify content from the filtered content store that is responsive to the search query. As another example, responsive content is identified based on semantic similarity between the content and the search query. Thus, it will be appreciated that any of a variety of searching techniques may be used, for example as may be used for a graph database and/or a relational database.

Moving to operation 556, an indication of the responsive content that was identified at operation 554 is provided in response to the search query that was received at operation 552. As noted above, the responsive content may be provided in paginated form, such that multiple requests for the responsive content may be processed at operation 556 as a device requests successive pages of responsive content. It will therefore be appreciated that any of a variety of techniques may be used to provide the content that was determined to be relevant to the search query and/or indicated categories/subcategories. As illustrated, method 550 terminates at operation 556.

It will be appreciated that a URL for content of a content hierarchy according to aspects described herein may be generated according to any of a variety of techniques. In examples, the URL is a descriptive URL that includes one or more subparts that each correspond to a node of a content hierarchy of the content platform (e.g., as were discussed above with respect to FIG. 2). For instance, a URL for a post (e.g., post 222) may include a subpart corresponding to user profile 210, a subpart corresponding to entity profile 212, a subpart corresponding to vendor profile 230, a subpart corresponding to category 202, and/or a subpart corresponding to subcategory 204. In examples, the order of such subparts corresponds to an associated depth within the hierarchy (e.g., category 202 as a first subpart, followed by subcategory 204 as a second subpart). As a result of incorporating such detail in a URL for content of the content platform, such content may be ranked more highly and/or indexed in a way that it is more easily identified by a user of a search platform, among other benefits.

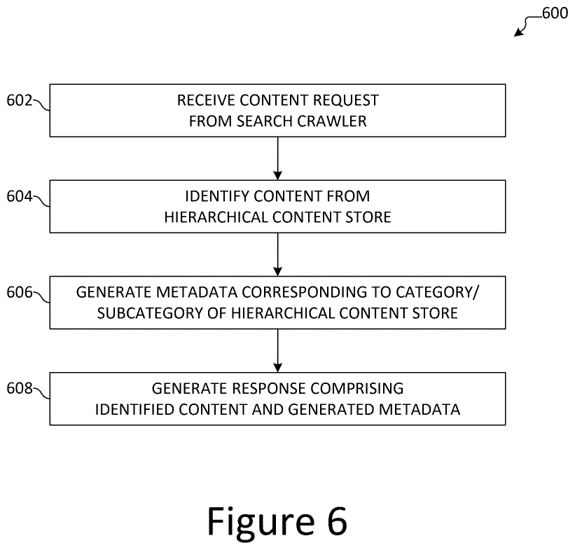

FIG. 6 illustrates an overview of an example method 600 for generating a response to a request from a search platform based on content from a hierarchical content store according to aspects described herein. In examples, aspects of method 600 are performed by a content platform, such as content platform 102 in FIG. 1. For instance aspects of method 600 may be performed by an SEO generator, such as SEO generator 116.

As illustrated, method 600 begins at operation 602, wherein a content request is received from a search crawler. As an example, the a search platform may operate the search crawler, such as search platform 106 in FIG. 1. In examples, the content request is for a specific page or other resource of the content platform. For instance, the content platform may provide a sitemap or other listing of content that is available from the content platform, such that the crawler accesses pages/resources enumerated by such a listing accordingly. In examples, the listing of content is generated based at least in part on a content hierarchy, thereby causing content relating to each category/subcategory to be indexed by the search platform, thereby facilitating content discovery from the content platform (e.g., by both users that do and do not have a user profile with the content platform).

Flow progresses to operation 604, where content is identified from the hierarchical content store based on the content request. For example, if the content request corresponds to a given category/subcategory, content may be identified that relates to the given category/subcategory. As another example, the content request may relate to a vendor profile, an SME profile, and/or a user profile, such that corresponding content is identified accordingly. In examples, the content is ranked and/or filtered to identify content that is most relevant to a given category/subcategory and/or that has the most user interaction, among other criteria. Thus, it will be appreciated that any of a variety of techniques may be used to identify content that is responsive to the received content request.

At operation 606, metadata is generated that corresponds to the category/subcategory of the hierarchical content store. For example, additional relevant keywords and/or topics may be determined based on an association between the identified content and categories/subcategories of the content hierarchy, which may be embedded in the response to the content request, thereby improving the indexability of the content from the content store. As another example, the content that was identified at operation 604 is processed to extract or otherwise generate keywords and/or topics having semantic relevance to the identified content, which may similarly be included to facilitate content discovery via the search platform.

Moving to operation 608, a response is generated that comprises the identified content and the generated metadata. Thus, the response to the content request comprises content that is further enriched with the metadata that was generated at operation 606, thereby providing additional context with which the content may be identified via the search platform. Additionally, or alternatively, the response comprises a URL comprising one or more descriptive subparts according to aspects described herein. Similarly, the response may comprise such metadata in a header, title, and/or description tag (e.g., in a hypertext markup language (HTML) document or extensible markup language (XML) document), among other examples. It will be appreciated that the metadata that is included alongside the content, within headers, and/or as one or more descriptive subparts of a URL need not be the same nor mutually exclusive.

Thus, as compared to instances where only the content would be provided in response to such a content request from a search crawler, organization based on the content hierarchy according to aspects described herein enables the content platform to include additional metadata in the response, which may increase the likelihood that a user is able to identify the content via the search platform. Additionally, such aspects may also improve the ranking of the content from the content platform by the search platform. Further, the content hierarchy may also improve indexing of the content platform, where the listing of content provided to the search crawler for indexing may be more readily generated and may have improved structure/organization as compared to instances where the listing of content is merely a list of all available pages of a website. As illustrated, method 600 terminates at operation 608.

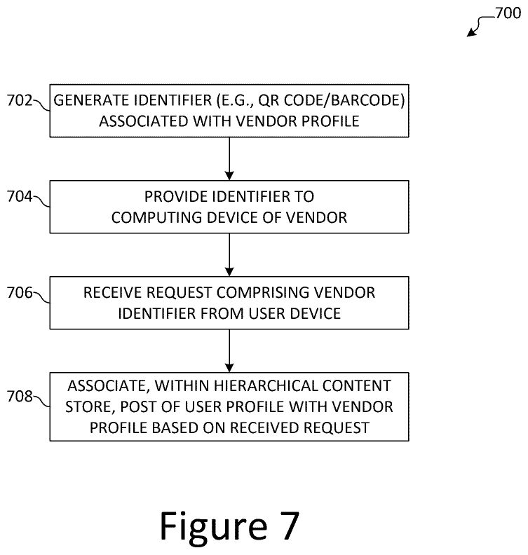

FIG. 7 illustrates an overview of an example method 700 for associating user-generated content with a profile based on an identifier associated with the profile according to aspects described herein. In examples, aspects of method 700 are performed by a content platform, such as content platform 102 in FIG. 1.

As illustrated, method 700 begins at operation 702, where an identifier associated with a vendor profile is generated. In examples, the identifier uniquely identifies the vendor profile and/or may be specified by the vendor (e.g., a username associated with the vendor profile on the content platform), among other examples. In some instances, the identifier comprises a quick response (QR) code and/or a barcode, among other examples, which may thus be readable by a user device (e.g., user device 104 in FIG. 1) to obtain the identifier accordingly. As another example, the identifier may be programmed onto a near-field communication (NFC) tag and/or printed for identification using optical character recognition. Thus, it will be appreciated that the identifier may ultimately be machine-readable using any of a variety of techniques.

Flow progresses to operation 704, where the identifier is provided to a computing device of the vendor. For example, the identifier may be provided in an electronic communication that is accessed by the vendor computing device and/or may be accessible via an application on the vendor computing device, among other examples. Accordingly, the vendor computing device may be used to make the identifier accessible to one or more user devices (e.g., as may be operated by users for which the vendor provides goods and/or services). While method 700 is illustrated as an example in which the identifier is provided to a vendor computing device, it will be appreciated that, in other examples, the identifier may be transferred to a physical medium (e.g., stored onto an NFC tag and/or printed out for display by the vendor), among other examples. Thus, any of a variety of additional or alternative operations may be performed at operation 704, or operation 704 may be omitted in other examples.

Moving to operation 706, a request is received comprising the vendor identifier from a user device. For example, an application of the user device (e.g., application 120 of user device 104 in FIG. 1) is used to scan or otherwise obtain the vendor identifier (e.g., as a result of scanning a QR code, a barcode, or an NFC tag comprising the vendor identifier). In examples, the request is received as part of a request to create a post at a content platform, examples of which were discussed above with respect to methods 400 and 450 in FIGS. 4A and 4B, respectively.

Accordingly, at operation 708, a post of the user profile is associated with a vendor profile corresponding to the vendor identifier. Thus, rather than a user manually tagging the vendor profile, scanning or otherwise obtaining the vendor identifier from the vendor enables a user device to provide the vendor identifier and thus cause the content platform to automatically associate content with the corresponding vendor profile accordingly. As illustrated, method 700 terminates at operation 708.

FIG. 8A illustrates an overview of an example method 800 for directing a user computing device to a vendor computing device according to aspects described herein. In examples, aspects of method 800 are performed by a content platform, such as content platform 102 in FIG. 1. For instance aspects of method 300 may be performed by a request referral engine, such as request referral engine 118.

As illustrated, method 800 begins at operation 802, where content is identified from a hierarchical content store that corresponds to a vendor profile. For example, operation 802 may be performed in response to a request for content from a user device (e.g., user device 104 in FIG. 1), such that the content is processed according to method 800 prior to providing the content in response to the request. As another example, aspects of method 800 are performed when content is posted to a content platform. In examples, it is determined that the content corresponds to a vendor profile as a result of an association between the content and a vendor profile within the hierarchical content store according to aspects described herein.

Flow progresses to operation 804, where a referral identifier is determined that is associated with the vendor profile. In examples, operation 804 comprises communicating with a referral manager (e.g., referral manager 128) to obtain such a referral identifier. As another example, the content platform generates the referral identifier and provides an indication of the referral identifier to the referral manager. It will therefore be appreciated that any of a variety of techniques may be used to determine the referral identifier for a given vendor profile.

At operation 806, the content that was identified at operation 802 is updated to include the referral identifier that was determined at operation 804, such that, at operation 808, the updated content is provided to a user device for display to a user. As a result of including the referral identifier in the updated content, the user device may generate a request to a computing device associated with the vendor profile that includes the referral identifier, thereby providing an indication to the computing device associated with the vendor profile that the request was referred by the content platform.

Thus, method 800 enables the automatic enrichment of content to include the referral identifier and/or for a vendor identifier to be dynamically changed (e.g., such that a referral manager may generate or otherwise issue a new referral identifier, thereby optionally invalidating an old referral identifier). As illustrated, method 800 terminates at operation 808.

FIG. 8B illustrates an overview of another example method 850 for directing a user computing device to a vendor computing device according to aspects described herein. In examples, aspects of method 850 are performed by a user device, such as user device 104 in FIG. 1. For instance aspects of method 300 may be performed by a request referral engine, such as request referral engine 118. As compared to method 800, method 850 incorporates a referral identifier as part of a request rather than as part of content that is provided from the content platform, such that the referral identifier is dynamically injected in response to actuation of content within a post (e.g., a link to a website of a vendor). It will be appreciated that the disclosed aspects are not mutually exclusive.

As illustrated, method 850 begins at operation 852, where an indication of a user actuation of content from a hierarchical content store is received. For example, an application of the user device (e.g., application 120 of user device 104 in FIG. 1) obtains and display content from a content platform (e.g., content platform 102), such that a user may interact with the content accordingly. As an example, the user actuation comprises clicking, tapping, or otherwise interacting with a link within a post.

Accordingly, at operation 854, a vendor profile associated with the content is identified. In examples, operation 854 comprises communicating with the content platform to request an indication as to which vendor profile is associated with the content within the hierarchical content store. In other examples, an indication of the vendor profile was obtained in conjunction with the content itself, as may be the case in instances where the content is presented to the user in conjunction with an indication as to an associated vendor profile (e.g., with a link and/or a tag corresponding to the vendor profile).

Flow progresses to operation 856, where a referral identifier associated with the vendor profile is determined. Aspects of operation 856 may be similar to those discussed above with respect to operation 804 and are therefore not necessarily redescribed in detail. In examples, the user device requests the referral identifier from the content platform, the content platform provides the referral identifier in conjunction with the content, and/or the user device requests the referral identifier from a referral manager, among other examples.

At operation 858, a request to a vendor computing device is generated that comprises the determined referral identifier. For example, as a result of the user action that was obtained at operation 852, a request is generated for a website included in the content, where the request includes an indication of the referral identifier, thereby indicating to the vendor computing device that the request resulted from the content platform. As noted above, operation 858 may instead dynamically embed the referral identifier within a request to the vendor computing device rather than including it within the content as was discussed above with respect to method 800 in FIG. 8A. As illustrated, method 850 terminates at operation 858.

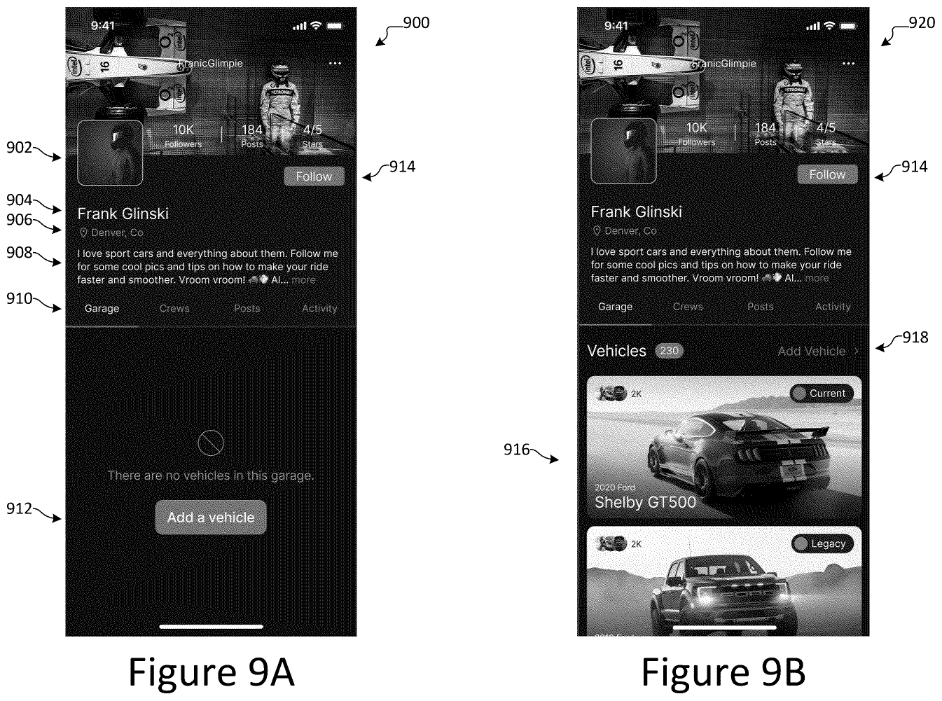

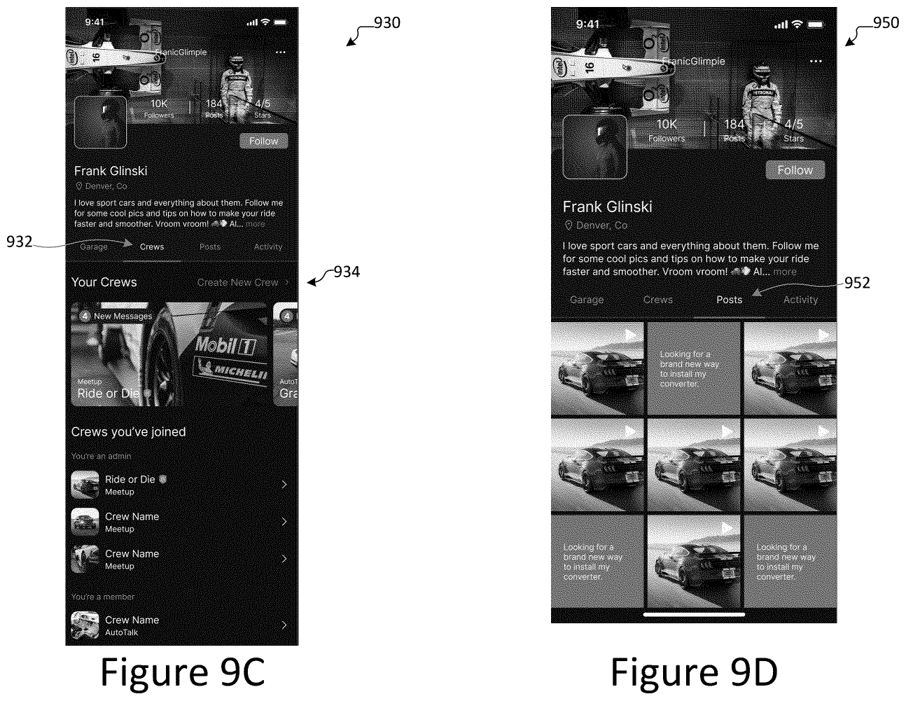

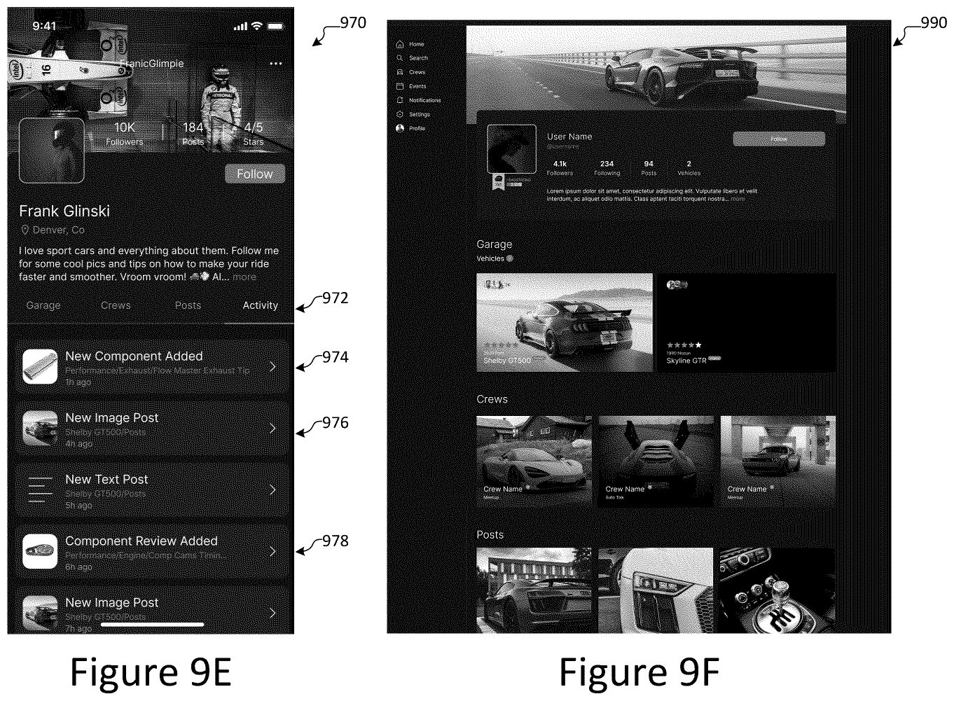

FIGS. 9A-9F illustrate overviews of example user interfaces 900, 920, 930, 950, 970, and 990 relating to a user profile according to aspects described herein. The illustrated user interfaces may be provided via a mobile computing device, but it will be appreciated that similar aspects may be provided as part of a user experience for any of a variety of other types of devices (e.g., a tablet computing device or a desktop computing device). As illustrated in FIGS. 9A and 9B, example user interfaces 900 and 920 depict an example “garage” tab for a user profile according to aspects described herein. Thus, while the present examples are provided for a content platform relating to vehicles, it will be appreciated that similar aspects may be used for any of a variety of other types of subject matter entities (e.g., a “library” for an audio/literature content platform or a “bag” for a golf content platform). As illustrated, user interfaces 900 and 920 comprise profile picture 902, user name field 904, user location field 906, user description field 908, and garage tab 910. Such fields may thus display user-provided content, such that the user may define/edit the fields accordingly. User interfaces 900 and 920 further comprise a “follow” button, thereby enabling other users of the content platform to follow the user and thus be provided new posts as the user generates new content on the content platform.

The example provided in user interface 900 lists no vehicles in region 912, such that the user may actuate the “add a vehicle” button to define a subject matter entity profile according to aspects described herein. User interface 920 is provided as an example in which region 916 is populated with subject matter entity profiles associated with the user profile, thereby enabling a user to actuate one of the entries and view a corresponding subject matter entity profile accordingly.

Turning now to FIG. 9C, example user interface 930 includes similar aspects to those discussed above with respect to user interfaces 900 and 920, which are therefore not redescribed in detail. As illustrated, user interface 930 depicts “crews” tab 932 of a user profile. In examples, a user of a content platform according to aspects described herein is able to join one or more “crews” or groups, which may have an associated list of members, events, and/or discussions, among other examples. Accordingly, crews tab 932 comprises a list of entries corresponding to crews of which the user is a member, which, as illustrated, may be sorted according to the user's role within the crew (e.g., administrator or member).

FIG. 9D depicts example user interface 950, which includes similar aspects to those discussed above with respect to user interfaces 900, 920, and 930, and are therefore not redescribed in detail. As illustrated, user interface 950 includes “posts” tab 952 of a user profile. As illustrated, posts tab 952 includes a grid via which a number of posts are displayed. It will be appreciated that any of a variety of additional or alternative displays may be provided. For example, posts tab 952 may additionally or alternatively include a list of user-generated content. In some examples, the content displayed via posts tab 952 is sorted (e.g., chronologically or by popularity) and/or filtered.

With respect to FIG. 9E, user interface 970 is depicted, which includes similar aspects to those discussed above with respect to user interfaces 900, 920, 930, and 950, and are therefore not redescribed in detail. As illustrated, user interface 970 includes “activity” tab 972, which comprises entries 974, 976, and 978 relating to recent activity by the user via the content platform. As illustrated, activity tab 972 includes entry 974 indicating the user added a new component, entry 976 indicting a new post, and entry 978 indicating a new review by the user of a component. While examples are described with respect to components of a vehicle, it will be appreciated that similar aspects may be used for any of a variety of other subject matters.

Finally, FIG. 9F is provided as an example user interface 990 for a desktop computing device, which incorporates similar aspects to those discussed above with respect to FIGS. 9A-9E but according to a different layout (e.g., that is better suited for a larger screen rather than that of a mobile computing device).

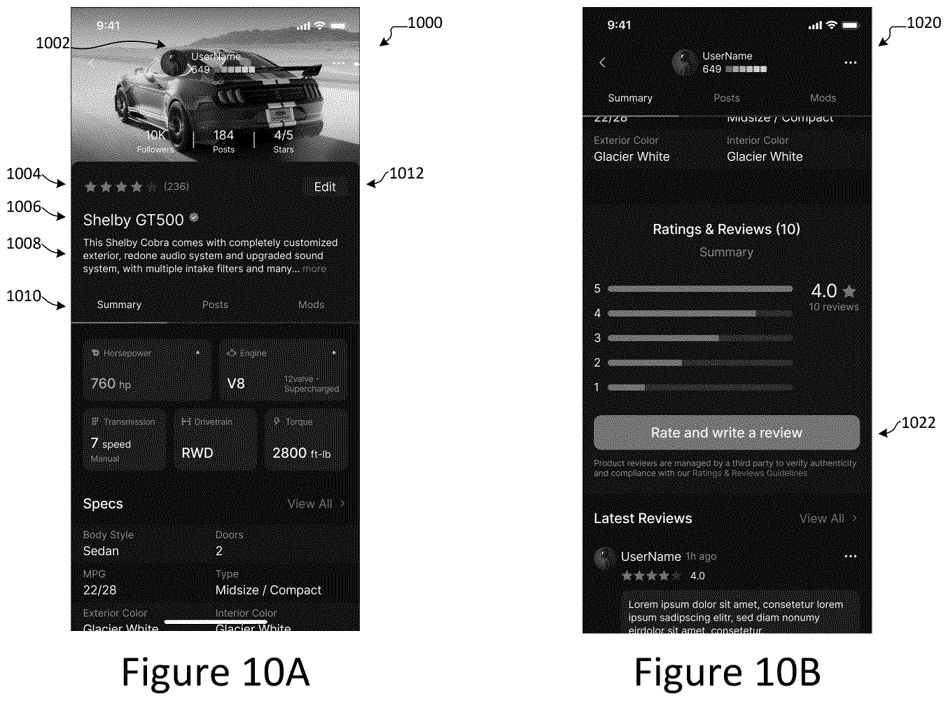

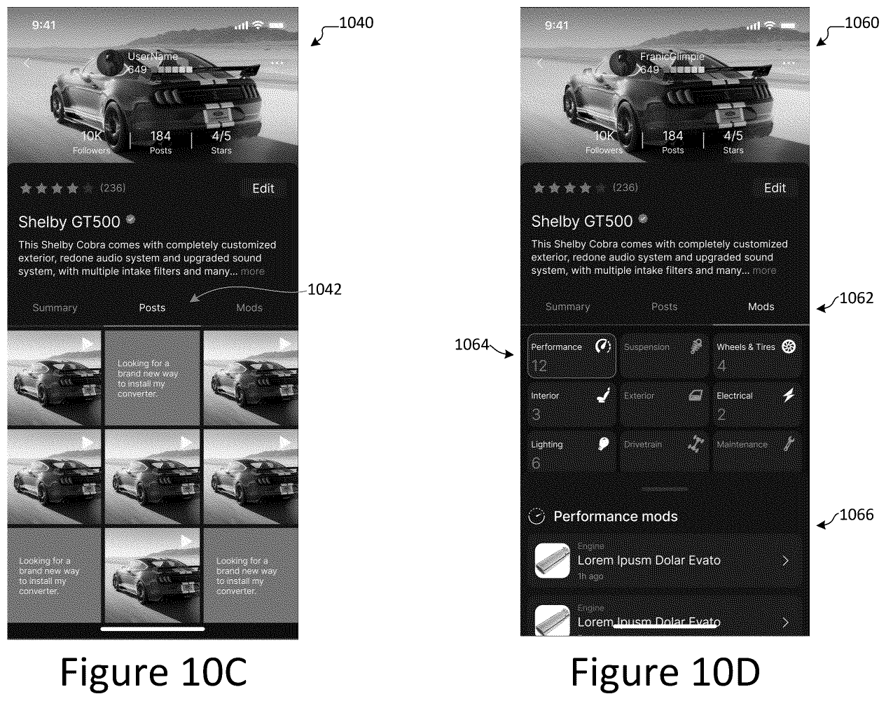

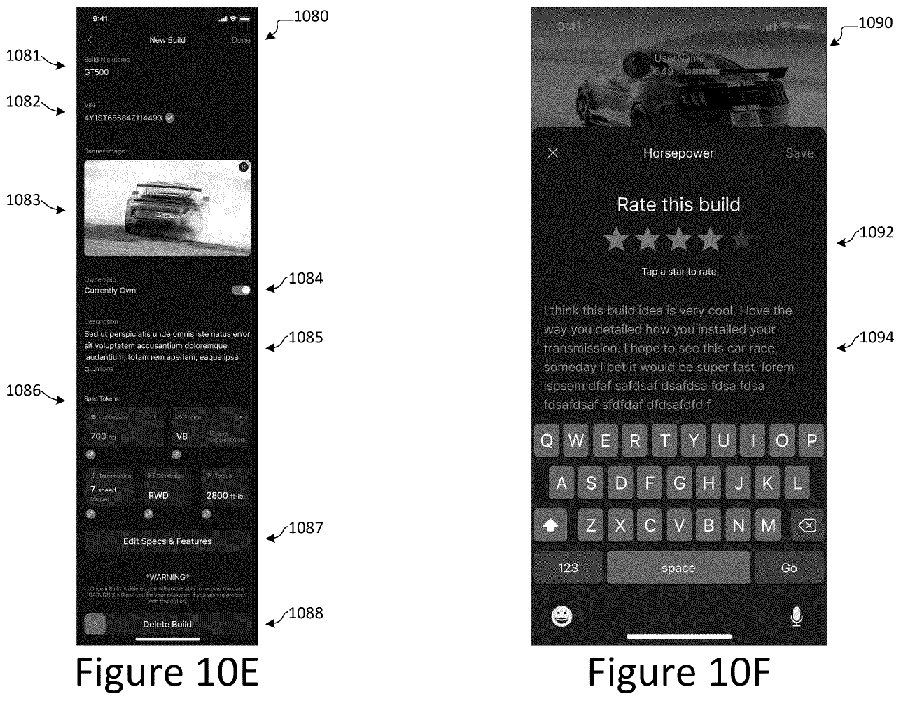

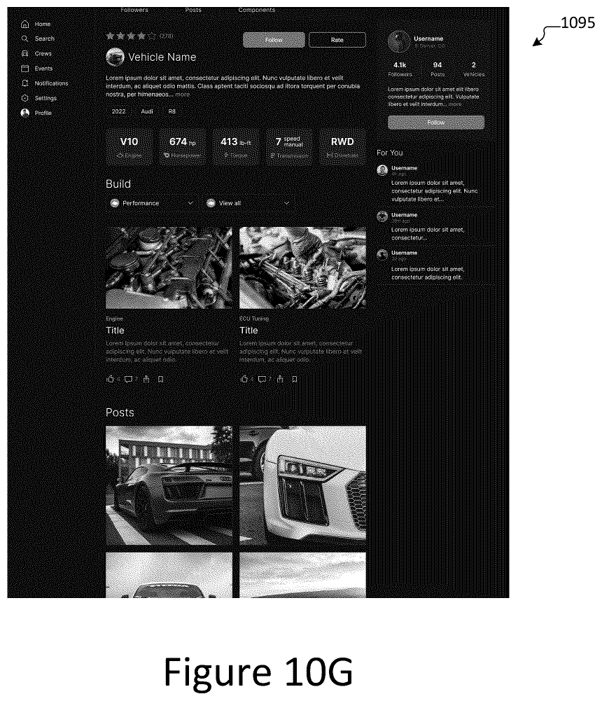

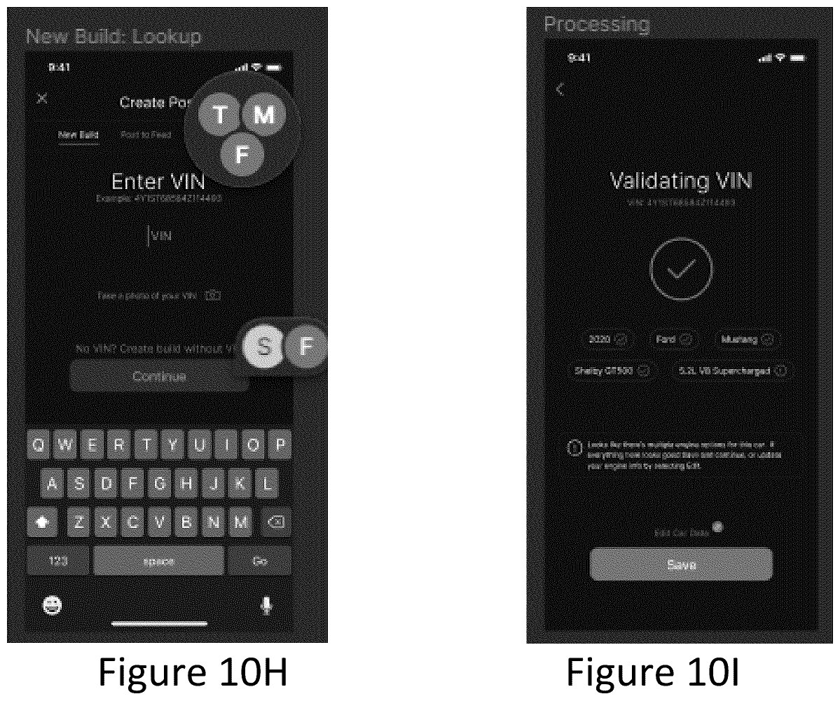

FIGS. 10A-10G illustrate overviews of example user interfaces 1000, 1020, 1040, 1060, 1080, 1090, and 1095 relating to a subject matter entity profile according to aspects described herein. The illustrated user interfaces may be provided via a mobile computing device, but it will be appreciated that similar aspects may be provided as part of a user experience for any of a variety of other types of devices (e.g., a tablet computing device or a desktop computing device). As illustrated in user interface 1000 of FIG. 10A, the subject matter entity profile comprises indication 1002 of a corresponding user profile, rating 1004, entity name 1006, entity description 1008, and entity summary tab 1010. Additionally, edit button 1012 is provided, thereby permitting an owner of the entity to which the subject matter entity profile relates may edit the entity profile accordingly according to aspects described herein. As illustrated, summary tab 1010 comprises a variety of information corresponding to the subject matter entity. It will be appreciated that similar aspects may be used to provide information relating to any of a variety of other types of subject matter entities.

User interface 1020 provides a scrolled view of the user interface discussed with respect to FIG. 10A, where additional summary information is available. Additionally, other users of the content platform are able to leave reviews relating to the subject matter entity (e.g., by actuating review button 1022), such that reviews are further displayed within summary tab 1010. Example user interface aspects relating to providing a review are discussed below with respect to FIG. 10F.

Turning now to FIG. 10C, user interface 1040 is provided which includes aspects similar to those discussed above with respect to user interfaces 1000 and 1020, and are therefore not redescribed in detail. As illustrated, user interface 1040 includes posts tab 1042. Aspects of posts tab 1042 may be similar to those discussed above with respect to posts tab 952 in FIG. 9D, where posts relating to the subject matter entity are displayed. Actuation of a post may thus display the post accordingly.

FIG. 10D depicts user interface 1060, which includes aspects similar to those discussed above with respect to user interfaces 1000, 1020, and 1040, which are therefore not redescribed in detail. As illustrated, user interface 1060 comprises “mods” tab 1062, where modifications relating to the subject matter entity are displayed. As illustrated, the modifications maybe categorized and/or sorted according to categories 1064 (e.g., which modifications 1066 are presented in relation to “performance” modifications). Actuation of one of categories 1064 may cause the modifications to be filtered or for the user interface to scroll to that specific category, among other examples. Actuation of a modification may display one or more corresponding posts relating to the subject matter entity accordingly. It will be appreciated that similar aspects may be used for any of a variety of other subject matters and need not specifically relate to modifications in other examples.

FIG. 10E illustrates user interface 1080, which may be used to define a subject matter entity profile according to aspects described herein. As illustrated, user interface 1080 comprises name field 1081, VIN field 1082, image 1083, ownership selector 1084, description field 1085, specification section 1086, edit button 1087, and delete user interface element 1088. Accordingly, an owner of the subject matter entity provides content relating to the entity to define the subject matter entity profile accordingly (e.g., according to aspects discussed above with respect to method 300 in FIG. 3A). For example, the owner actuates button 1087 to add/update/remove information accordingly. In examples, the owner actuates delete user interface element 1088 to delete the entity profile.

Ownership selector 1084 is provided to indicate whether the entity has since been transferred to another user according to aspects described herein. In examples, various aspects of specification section 1086 may be automatically populated (e.g., based on a VIN entered in VIN field 1082). It will be appreciated that any of a variety of alternative or additional fields may be used to define any of a variety of other types of subject matter entities.

FIG. 10F depicts example user interface 1090 with which a user may review a subject matter entity profile accordingly. As illustrated, a user can select a rating using rating selector 1092 and provide a rating description via rating description input field 1094. The rating may thus be stored in association with a subject matter entity profile and/or category/subcategory according to aspects described herein.

Finally, FIG. 10G is provided as an example user interface 1095 for a desktop computing device, which incorporates similar aspects to those discussed above with respect to FIGS. 10A-10F but according to a different layout (e.g., that is better suited for a larger screen rather than that of a mobile computing device).

FIGS. 10H and 10I illustrate example user interface aspects where a user may enter an identifier corresponding to a subject matter entity (e.g., a VIN for a vehicle in the depicted example), such that information associated with the entity is automatically identified accordingly (e.g., as in FIG. 10I). Once a user inputs the identifier and actuates the “continue” user interface element, the display progresses from FIG. 10H to FIG. 10I, where a display comprising information identified based on the identifier is presented. As illustrated, automatically obtained information that matches user-provided information is depicted using a first indicator (e.g., a checkmark), whereas automatically obtained information that does not match user-provided information is depicted using a second indicator (e.g., an “x”). Accordingly, the user may correct such discrepancies and/or indicate that a deviation from automatically obtained information is correct (e.g., as a result of an aftermarket modification).

FIGS. 11A-11F illustrate overviews of example user interfaces 1100, 1120, 1140, 1150, 1160, and 1180 relating to creating user-generated content according to aspects described herein. The illustrated user interfaces may be provided via a mobile computing device, but it will be appreciated that similar aspects may be provided as part of a user experience for any of a variety of other types of devices (e.g., a tablet computing device or a desktop computing device).

As illustrated in FIGS. 11A and 11B, example user interfaces 1100 and 1120 depict an user interface for selecting a destination for a post. For example, a post may be associated with a user profile (e.g., as indicated by checkmark 1102) or with a profile of a subject matter entity (e.g., as indicated by checkmark 1122). For example, the selected user profile may be similar to the aspects discussed above with respect to FIGS. 9A-9F, while the selected entity profile may be similar to the aspects discussed above with respect to FIGS. 10A-10G.

Turning to FIG. 11C, user interface 1140 depicts a user interface with which a user creates a post, specifically as may be posted to a user profile (e.g., as indicated by profile indicator element 1142). A user operates user interface 1140 to input a title in title field 1144, to upload media via media selector 1145, to provide a description in description field 1146, to specify a link for the post via URL field 1147, and/or to specify one or more tags via tag selector 1148.

FIG. 11D illustrates user interface 1150 with which a user authors a post for a specified subject matter entity. Specifically, user interface element 1152 depicts the selected entity (e.g., as was selected via user interface 1120 in FIG. 11B). Aspects of user interface 1150 are similar to those discussed above with respect to user interface 1140 and are therefore not redescribed in detail. For example, the user provides a title, uploads media, and/or can provide a description/link for the post.

User interface 1150 further comprises post type selector 1154, where the user can select between a post and a modification (e.g., which may thus be associated with a specific category/subcategory). If the user actuates selector 1154 to indicate a modification post is being provided, user interface 1150 may be updated to interfaces 1160 and 1180 depicted in FIGS. 11E and 11F. Specifically, the user interface provides category selector 1162 and 1182 via which a category/subcategory may be selected for the modification post. As illustrated in FIG. 11F, the category/subcategory is selected to be “performance” and “exhaust” accordingly. Thus, FIG. 11F provides an example user interface 1180 in which the user has provided content within the fields to thus be submitted and categorized by the content platform according to aspects described herein.

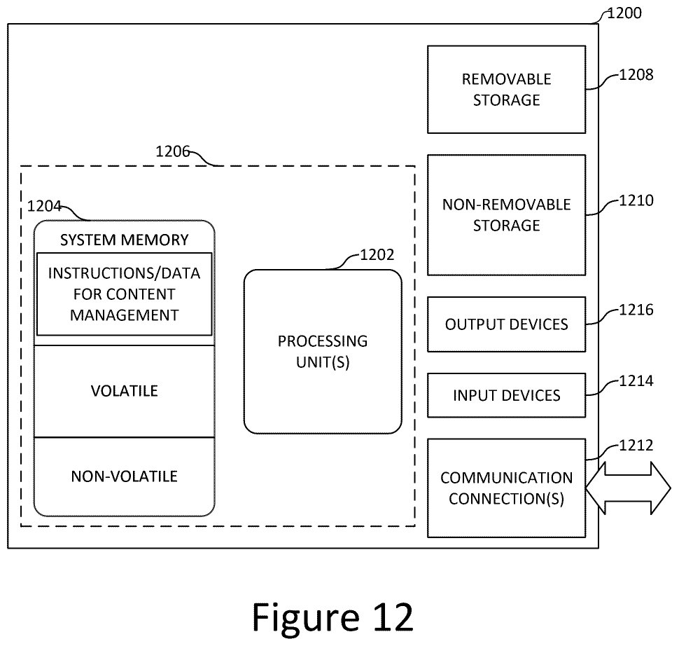

FIG. 12 illustrates an example of a suitable computing environment 1200 in which one or more of the present embodiments may be implemented. For example, aspects of computing environment 1200 may be used by a device, such as a device of content platform 102, user device 104, a device of search platform 106, and/or a device of referral target 108 in FIG. 1. This is only one example of a suitable computing environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, computing environment 1200 typically may include at least one processing unit 1202 and memory 1204. Depending on the exact configuration and type of computing device, memory 1204 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 12 by dashed line 1206. Further, environment 1200 may also include storage devices (removable, 1208, and/or non-removable, 1210) including, but not limited to, magnetic or optical disks or tape. Similarly, environment 1200 may also have input device(s) 1214 such as a keyboard, mouse, pen, voice input, etc. and/or output device(s) 1216 such as a display, speakers, printer, etc. Also included in the environment may be one or more communication connections, 1212, such as LAN, WAN, point to point, etc.

Computing environment 1200 may include at least some form of computer readable media. The computer readable media may be any available media that can be accessed by processing unit 1202 or other devices comprising the computing environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The computing environment 1200 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets, and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 1204. While executing on the processing unit 1202, program modules (e.g., applications, Input/Output (I/O) management, and other utilities) may perform processes including, but not limited to, one or more of the stages of the operational methods described herein.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 12 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing environment 1200 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: a processor; and a memory storing instructions that, when executed by the processor, cause the processor to perform a set of operations. The set of operations comprises: receiving, from a first user device of a user, an indication to generate a content post within a hierarchical content store, the hierarchical content store comprising a set of categories, wherein each category of the set of categories has an associated set of subcategories; generating, in response to the indication, the content post within the hierarchical content store; generating, within the hierarchical content store, an association between the content post and at least one of a category of the set of categories or a subcategory of an associated set of subcategories for the category; receiving, from a second user device, a request for content from the hierarchical content store, wherein the request comprises an indication of at least one of the category or the subcategory; identifying, based on the indication of the request and the generated association, the post within the hierarchical content store; and providing, in response to the request for content, the identified post for display by the second user device. In an example, the set of operations further comprises generating another association between the post and at least one of a user profile of the user and a subject matter entity (SME) profile of the user. In another example, the request for content further comprises an indication of one or more filter criteria and identifying the post within the hierarchical content store further comprises determining the post satisfies the one or more filter criteria. In a further example, the set of operations further comprises generating an association between the post and a vendor profile of the hierarchical content store. In yet another example, providing the identified post further comprises: identifying, based on an association between the post and a vendor profile within the hierarchical content store, a vendor corresponding to the post; determining, for the vendor, a referral identifier; and processing the post to embed the referral identifier, thereby causing the second user device to provide the referral identifier when requesting content from a computing device of the vendor. In a further still example, the request for content further comprises a search query and identifying the post within the hierarchical content store further comprises determining the post is relevant to the search query. In another example, determining the post is relevant to the search query comprises at least one of performing keyword searching within content of the post or evaluating a semantic similarity between the content and the search query. In a further example, the post comprises at least one of textual content, audio content, image content, or video content.

In another aspect, the technology relates to a method for generating a subject matter entity (SME) profile within a hierarchical content store for an SME. The method comprises: receiving, via a user interface of a user device, an indication to create a new SME profile at a content platform; obtaining, by the user device, SME information corresponding to the SME; providing the SME information to the content platform for validation, thereby causing the content platform to generate a new SME profile comprising the SME information; and providing, via the user interface, an indication that the new SME profile has been created. In an example, obtaining the SME information comprises presenting a set of properties and receiving, via the user interface, user input of a value corresponding to each property of the set of properties; and the SME information comprises values corresponding to the set of properties. In another example, obtaining SME information comprises at least one of receiving user selection of media on the user device or capturing media at the user device to include as SME information for the new SME profile. In a further example, at least a part of the SME information obtained by the user device is pre-populated by the content platform; and obtaining the SME information further comprises user customization of the pre-populated SME information. In yet another example, the SME information comprises at least one of textual content, audio content, image content, or video content relating to the SME.

In a further aspect, the technology relates to a method for providing content in response to a request from a search crawler of a search platform. The method comprises: receiving, from the search crawler, a request for content from a hierarchical content store of a content platform; identifying, from the hierarchical content store, responsive content for the request for content; generating metadata for the identified responsive content based on one or more associations between the responsive content within the hierarchical content store; enriching the responsive content with the generated metadata to generate enriched content; and providing, in response to the request for content, the enriched content. In an example, the one or more associations comprises at least one of: an association between the content and a user profile of the content platform; an association between the content and a vendor profile of the content platform; an association between the content and a subject matter entity (SME) profile of the content platform; an association between the content and a category of the hierarchical content store; or an association between the content and a subcategory for a given category of the hierarchical content store. In another example, the responsive content is identified from the hierarchical content store as a result of the one or more associations for the responsive content within the hierarchical content store. In a further example, the request for content is received from the search crawler based on a listing of content generated by the content platform, wherein the listing of content is based on a content hierarchy of the hierarchical content store. In yet another example, the responsive content comprises content from a plurality of posts of the hierarchical content store and the plurality of posts are each related to at least one of a category or a subcategory for a given category of the hierarchical content store. In a further example, the responsive content is further identified based on at least one of keyword matching or semantic similarity between the responsive content and the request for content. In another example, the responsive content is accessible from the content platform by a user device for a user that does not have a user profile with the content platform.

In yet another aspect, the technology relates to a system comprising: a processor; and a memory storing instructions that, when executed by the processor, cause the processor to perform a set of operations. The set of operations comprises: receiving, from a search indexer, a request for content of a content platform; identifying, from a content data store of the content platform, content responsive to the request for content; generating, based on an association between the identified content and a category in a content hierarchy of the content platform, metadata for the identified content that corresponds to the category in the content hierarchy; and generating, in response to the request for content, a response comprising the identified content and the generated metadata. In an example, the association between the identified content and the category further comprises an association between the identified content and a subcategory of the category; and the generated metadata further comprises an indication of the associated subcategory. In another example, the identified content comprises one or more of: a user profile of the content platform; an entity profile of the content platform; or a post by a user of the content platform. In a further example, the identified content comprises: content from a post by a user of the content platform; and based on an association between the post and a user profile of the user, content from the associated user profile. In yet another example, the identified content comprises: content from a post by a user of the content platform; and based on an association between the post and an entity profile, content from the associated entity profile. In a further still example, the generated metadata comprises at least one of a keyword or a topic for the associated category of the content hierarchy. In another example, generating the metadata further comprises generating a set of semantic keywords based on the identified content.

In another aspect, the technology relates to a method for enriching content with metadata based on a content hierarchy of search engine optimization. The method comprises: receiving, from a search indexer, a request for content of a content platform; identifying, from a content data store of the content platform, a post of the content platform that is responsive to the request for content; determining, based on the identified post: a category in a content hierarchy of the content platform that is associated with the identified post; and a profile of the content platform that is associated with the identified post; generating metadata for the identified post that includes an indication of the identified category and content of the identified profile; and providing, in response to the request for content, a response comprising the identified post and the generated metadata. In an example, the identified post is further associated with a subcategory of the category; and the generated metadata further comprises an indication of the associated subcategory. In another example, the profile is a user profile for a user that created the post. In a further example, the profile is an entity profile for an entity related to the post. In yet another example, the generated metadata comprises at least one of a keyword or a topic for the associated category of the content hierarchy. In a further still example, generating the metadata further comprises generating a set of semantic keywords based on the identified post of the content platform.

In a further aspect, the technology relates to another method for enriching content with metadata based on a content hierarchy of search engine optimization. The method comprises: receiving, from a search indexer, a request for content of a content platform; identifying, from a content data store of the content platform, content responsive to the request for content; generating, based on an association between the identified content and a category in a content hierarchy of the content platform, metadata for the identified content that corresponds to the category in the content hierarchy; and generating, in response to the request for content, a response comprising the identified content and the generated metadata. In an example, the association between the identified content and the category further comprises an association between the identified content and a subcategory of the category; and the generated metadata further comprises an indication of the associated subcategory. In another example, the identified content comprises one or more of: a user profile of the content platform; an entity profile of the content platform; or a post by a user of the content platform. In a further example, the identified content comprises: content from a post by a user of the content platform; and based on an association between the post and a user profile of the user, content from the associated user profile. In yet another example, the identified content comprises: content from a post by a user of the content platform; and based on an association between the post and an entity profile, content from the associated entity profile. In a further still example, the generated metadata comprises at least one of a keyword or a topic for the associated category of the content hierarchy. In another example, generating the metadata further comprises generating a set of semantic keywords based on the identified content.

In yet another aspect, the technology relates to a system comprising: a processor; and a memory storing instructions that, when executed by the processor, cause the processor to perform a set of operations. The set of operations comprises: generating an identifier for a profile of a content platform; providing the identifier to a first computing device of a user associated with the profile; receiving, from a second computing device, a request comprising an indication of the identifier; generating, based on the received request, a post in a content data store; and associating, based on the indication of the identifier included in the request, the generated post with the profile. In an example, the user is a first user; the profile is a first profile associated with the first user; and the generated post is further associated with a second profile associated with a second user of the second computing device. In another example, the set of operations further comprises: receiving, from a third computing device, a request for the generated post; and providing, in response to the request for the generated post, content of the post and an indication of an association between the post and the first profile. In a further example, the set of operations further comprises: receiving, from the third computing device and after providing the content of the post, a request for the first profile of the content platform; and providing, in response to the request for the first profile, content associated with the first profile of the content platform. In yet another example, the content of the post is further provided with an indication of an association between the post and the second profile. In a further still example, the generated post is further associated with an entity profile of the content platform. In another example, the generated is provided to the first computing device as a quick response (QR) code; and the request is received from the second computing device as a result of the second computing device scanning the QR code.

In another aspect, the technology relates to a method for processing content to include a profile identifier. The method comprises: identifying, from a content data store of a content platform, content associated with a profile, wherein the content is associated with the profile; obtaining an identifier associated with the profile; processing the identified content to include the identifier in association with the reference to the profile; and providing, to a computing device, the processed content including the identifier associated with the profile. In an example, obtaining the identifier comprises: generating the identifier associated with the profile; or communicating with a computing device associated with the profile to obtain the identifier. In another example, the processed content comprises a uniform resource locator (URL) associated with the profile, and wherein the identifier associated with the profile is included as part of the URL. In a further example, providing the processed content to the computing device further causes the computing device to provide the identifier to another computing device that is associated with the profile, thereby indicating a referral from the content platform. In yet another example, the content is associated with the profile by an association formed between the identified content and the profile within the content data store of the content platform. In a further still example, content is associated with the profile by an indication that is included within the identified content.

In a further aspect, the technology relates to a method for associating content with a profile of a content platform. The method comprises: generating an identifier for the profile of the content platform; providing the identifier to a first computing device of a user associated with the profile; receiving, from a second computing device, a request comprising an indication of the identifier; generating, based on the received request, a post in a content data store; and associating, based on the indication of the identifier included in the request, the generated post with the profile. In an example, the user is a first user; the profile is a first profile associated with the first user; and the generated post is further associated with a second profile associated with a second user of the second computing device. In another example, the method further comprises: receiving, from a third computing device, a request for the generated post; and providing, in response to the request for the generated post, content of the post and an indication of an association between the post and the first profile. In a further example, the method further comprises: receiving, from the third computing device and after providing the content of the post, a request for the first profile of the content platform; and providing, in response to the request for the first profile, content associated with the first profile of the content platform. In yet another example, the content of the post is further provided with an indication of an association between the post and the second profile. In a further still example, the generated post is further associated with an entity profile of the content platform. In another example, the generated is provided to the first computing device as a quick response (QR) code; and the request is received from the second computing device as a result of the second computing device scanning the QR code.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system, comprising:
a processor; and
a memory storing instructions that, when executed by the processor, cause the processor to perform a set of operations, the set of operations comprising:
receiving, from a first user device of a user, an indication to generate a content post within a hierarchical content store, the hierarchical content store comprising a set of categories, wherein each category of the set of categories has an associated set of subcategories;
generating, in response to the indication, the content post within the hierarchical content store;
generating, within the hierarchical content store, an association between the content post and at least one of a category of the set of categories or a subcategory of an associated set of subcategories for the category;
receiving, from a second user device, a request for content from the hierarchical content store, wherein the request comprises an indication of at least one of the category or the subcategory;
identifying, based on the indication of the request and the generated association, the post within the hierarchical content store; and
providing, in response to the request for content, the identified post for display by the second user device.

2. The system of claim 1, wherein the set of operations further comprises generating another association between the post and at least one of a user profile of the user and a subject matter entity (SME) profile of the user.

3. The system of claim 1, wherein the request for content further comprises an indication of one or more filter criteria and identifying the post within the hierarchical content store further comprises determining the post satisfies the one or more filter criteria.

4. The system of claim 1, wherein the set of operations further comprises generating an association between the post and a vendor profile of the hierarchical content store.

5. The system of claim 1, wherein providing the identified post further comprises:
identifying, based on an association between the post and a vendor profile within the hierarchical content store, a vendor corresponding to the post;
determining, for the vendor, a referral identifier; and
processing the post to embed the referral identifier, thereby causing the second user device to provide the referral identifier when requesting content from a computing device of the vendor.

6. The system of claim 1, wherein the request for content further comprises a search query and identifying the post within the hierarchical content store further comprises determining the post is relevant to the search query.

7. The system of claim 6, wherein determining the post is relevant to the search query comprises at least one of performing keyword searching within content of the post or evaluating a semantic similarity between the content and the search query.

8. The system of claim 1, wherein the post comprises at least one of textual content, audio content, image content, or video content.

9. A method for generating a subject matter entity (SME) profile within a hierarchical content store for an SME, the method comprising:
receiving, via a user interface of a user device, an indication to create a new SME profile at a content platform;
obtaining, by the user device, SME information corresponding to the SME;
providing the SME information to the content platform for validation, thereby causing the content platform to generate a new SME profile comprising the SME information; and
providing, via the user interface, an indication that the new SME profile has been created.

10. The method of claim 9, wherein:
obtaining the SME information comprises presenting a set of properties and receiving, via the user interface, user input of a value corresponding to each property of the set of properties; and
the SME information comprises values corresponding to the set of properties.

11. The method of claim 9, wherein obtaining SME information comprises at least one of receiving user selection of media on the user device or capturing media at the user device to include as SME information for the new SME profile.

12. The method of claim 9, wherein:
at least a part of the SME information obtained by the user device is pre-populated by the content platform; and
obtaining the SME information further comprises user customization of the pre-populated SME information.

13. The method of claim 9, wherein the SME information comprises at least one of textual content, audio content, image content, or video content relating to the SME.

14. A method for providing content in response to a request from a search crawler of a search platform, the method comprising:
receiving, from the search crawler, a request for content from a hierarchical content store of a content platform;
identifying, from the hierarchical content store, responsive content for the request for content;
generating metadata for the identified responsive content based on one or more associations between the responsive content within the hierarchical content store;
enriching the responsive content with the generated metadata to generate enriched content; and
providing, in response to the request for content, the enriched content.

15. The computer storage media of claim 14, wherein the one or more associations comprises at least one of:
an association between the content and a user profile of the content platform;
an association between the content and a vendor profile of the content platform;
an association between the content and a subject matter entity (SME) profile of the content platform;
an association between the content and a category of the hierarchical content store; or
an association between the content and a subcategory for a given category of the hierarchical content store.

16. The computer storage media of claim 15, wherein the responsive content is identified from the hierarchical content store as a result of the one or more associations for the responsive content within the hierarchical content store.

17. The computer storage media of claim 14, wherein the request for content is received from the search crawler based on a listing of content generated by the content platform, wherein the listing of content is based on a content hierarchy of the hierarchical content store.

18. The computer storage media of claim 14, wherein the responsive content comprises content from a plurality of posts of the hierarchical content store and the plurality of posts are each related to at least one of a category or a subcategory for a given category of the hierarchical content store.

19. The computer storage media of claim 14, wherein the responsive content is further identified based on at least one of keyword matching or semantic similarity between the responsive content and the request for content.

20. The computer storage media of claim 14, wherein the responsive content is accessible from the content platform by a user device for a user that does not have a user profile with the content platform.
